(19) United States
(12) Patent Application Publication
(10) Pub. No.: US 2024/0087831 A1
(43) Pub. Date: Mar. 14, 2024

(54) FUSED ELECTRICAL PROTECTION ASSEMBLIES AND SURGE PROTECTIVE DEVICES

(71) Applicant: RIPD IP DEVELOPMENT LTD, Nicosia (CY)

(72) Inventors: Zumret Topcagic, Ljubljana (SI); Robert Rozman, Smlednik (SI); Blaž; Rozman, Jesenice (SI); Rok Žunic, Ljubljana (SI)

(21) Appl. No.: 18/455,692

(22) Filed: Aug. 25, 2023

Related U.S. Application Data
(60) Provisional application No. 63/375,588, filed on Sep. 14, 2022.
(60) Provisional application No. 63/375,591, filed on Sep. 14, 2022.
(60) Provisional application No. 63/493,026, filed on Mar. 30, 2023.

(51) Int. Cl. H01H 85/055; H01H 85/20

(52) U.S. Cl. CPC H01H 85/055; H01H 85/20; H01H 2085/0283

(57) ABSTRACT

An electrical protection assembly includes a semiconductive gap-assisted (SGA) fuse assembly forming an overcurrent protection circuit. The SGA fuse assembly includes a fuse element and a semiconductive gap assembly electrically connected in series with the fuse element. The semiconductive gap assembly includes: a first gap electrode and an opposing second gap electrode; a trigger gap defined between the first and second gap electrodes; and a semiconductive member disposed in the trigger gap. The semiconductive member is configured to assist in initiation of an electrical arc flashover across the trigger gap between the first and second gap electrodes responsive to an overvoltage developed across the first and second gap electrodes.

### RELATED APPLICATION(S)

The present application claims the benefit of and priority from U.S. Provisional Patent Application No. 63/493,026, filed Mar. 30, 2023, U.S. Provisional Patent Application No. 63/375,591, filed Sep. 14, 2022, and U.S. Provisional Patent Application No. 63/375,588, filed Sep. 14, 2022, the disclosures of which are incorporated herein by reference.

### FIELD

The present invention relates to fuse assemblies and surge protective devices (SPDs).

### BACKGROUND

Frequently, excessive voltage or current is applied across or through service lines that deliver power to residences and commercial and institutional facilities. Such excess voltage or current spikes (transient overvoltages and surge currents) may result from lightning strikes, for example. The above events may be of particular concern in telecommunications distribution centers, hospitals and other facilities where equipment damage caused by overvoltages and/or current surges is not acceptable and resulting downtime may be very costly.

Typically, sensitive electronic equipment may be protected against transient overvoltages and surge currents using surge protective devices (SPDs). For example, an overvoltage protection device may be installed at a power input of equipment to be protected, which is typically protected against overcurrents when it fails. Typical failure mode of an SPD is a short circuit. The overcurrent protection typically used is a combination of an internal thermal disconnector to protect the SPD from overheating due to increased leakage currents and an external fuse to protect the SPD from higher fault currents. Different SPD technologies may avoid the use of the internal thermal disconnector because, in the event of failure, they change their operation mode to a low ohmic resistance.

SPDs may use one or more active voltage switching/limiting components, such as a varistor or gas discharge tube, to provide overvoltage protection. These active voltage switching/limiting components may degrade at a rapid pace as they approach the end of their operational lifespans, which may result in their exhibiting continuous short circuit behavior.

### SUMMARY

According to some embodiments, an electrical protection assembly includes a semiconductive gap-assisted (SGA) fuse assembly forming an overcurrent protection circuit. The SGA fuse assembly includes a fuse element and a semiconductive gap assembly electrically connected in series with the fuse element. The semiconductive gap assembly includes: a first gap electrode and an opposing second gap electrode; a trigger gap defined between the first and second gap electrodes; and a semiconductive member disposed in the trigger gap. The semiconductive member is configured to assist in initiation of an electrical arc flashover across the trigger gap between the first and second gap electrodes responsive to an overvoltage developed across the first and second gap electrodes.

In some embodiments, the semiconductive member is formed of a composition including a mixture of a polymeric material, as a nonconductive matrix, and an electrically conductive filler.

In some embodiments, the semiconductive member is formed of a semiconductive ceramic selected from the group consisting of zinc oxide, barium titanate, and silicon carbide.

In some embodiments, the fuse element is a bimetallic fuse element including a first metal layer having a first coefficient of thermal expansion, and a second metal layer having a second coefficient of thermal expansion. The first coefficient of thermal expansion is greater than the second coefficient of thermal expansion. The bimetallic fuse element is configured to disintegrate in response to a current flowing through the bimetallic fuse element. The bimetallic fuse element is configured to bend in a deformation direction, due to the difference in the coefficients of thermal expansion of the first and second metal layers, in response to heat generated in the bimetallic fuse element by the current flowing through the bimetallic fuse element. Said bending assists in extinguishing electrical arcing from the bimetallic fuse element.

According to some embodiments, a portion of the fuse element forms the first gap electrode or the second gap electrode.

In some embodiments, the electrical protection assembly includes a second fuse element and the semiconductive gap assembly is connected in electrical series between the first and second fuse elements.

In some embodiments, a portion of the first fuse element forms the first gap electrode, and a portion of the second fuse element forms the second gap electrode.

According to some embodiments, the electrical protection assembly includes a thermal disconnect mechanism configured to disconnect the overcurrent protection circuit in response to a current insufficient to disintegrate the fuse element.

In some embodiments, the thermal disconnect mechanism includes a spring-loaded electrode and a meltable retainer.

According to some embodiments, the electrical protection assembly includes a deion chamber connected in electrical in series with the semiconductive gap assembly.

In some embodiments, wherein the deion chamber is connected in electrical series with the fuse element.

In some embodiments, the deion chamber is connected in electrical parallel with the fuse element.

In some embodiments, the deion chamber includes a set of serially spaced apart deion plates, and the fuse element extends along and in contact with the deion plates.

According to some embodiments, the electrical protection assembly includes an overcurrent failure indicator system configured to signal when the overcurrent protection circuit is interrupted.

In some embodiments, the overcurrent failure indicator system is electronic.

According to some embodiments, the electrical protection assembly is a fused surge protective device (SPD) including an overvoltage protection circuit connected in electrical series with the SGA fuse assembly to form a fused SPD circuit.

In some embodiments, the fused SPD includes an SPD module housing and first and second electrical terminals on the SPD module housing, and the overvoltage protection circuit and the overvoltage protection circuit are disposed in the SPD module housing.

In some embodiments, the overvoltage protection circuit includes a voltage-switching/limiting component.

In some embodiments, the voltage-switching/limiting component is a varistor, a spark gap, a diode or a thyristor.

In some embodiments, the overvoltage protection circuit includes a gas discharge tube connected in electrical series with the voltage-switching/limiting component.

In some embodiments, the overvoltage protection circuit includes a thermal disconnect mechanism configured to interrupt the fused SPD circuit in response to heat from the voltage-switching/limiting component and/or from the semiconductive gap assembly.

In some embodiments, the thermal disconnect mechanism includes a solder joint.

In some embodiments, the overvoltage protection circuit includes a fail-safe mechanism configured to short circuit the overvoltage protection circuit in response to heat from the voltage-switching/limiting component.

In some embodiments, the electrical protection assembly includes a third gap electrode and a main spark gap defined at least in part by the third gap electrode, wherein the electrical protection assembly is configured such that the electrical arc flashover will propagate into and through the main spark gap from the trigger gap.

In some embodiments, the electrical protection assembly includes a varistor and/or a gas discharge tube connected in electrical series with the semiconductive member and in electrical parallel with the main spark gap.

In some embodiments, the electrical protection assembly includes a deion chamber connected in electrical series with semiconductive gap assembly.

In some embodiments, the electrical protection assembly includes an overcurrent failure indicator system configured to signal when the overcurrent protection circuit is interrupted, and an overvoltage indicator system configured to signal when the overvoltage protection circuit is interrupted.

In some embodiments, the electrical protection assembly includes an SPD module including the overvoltage protection circuit, and a fuse assembly module. The fuse assembly module is mounted on and secured to the SPD module such that the SPD module and the fuse assembly module in combination form a unitary fused SPD module.

According to some embodiments, the SPD module includes: a housing electrode including an end wall and an integral sidewall collectively defining a cavity, wherein the housing electrode is unitarily formed of metal; a piston electrode extending into the cavity; and a varistor wafer disposed in the cavity between the housing electrode and the piston electrode; and the fuse assembly module is mounted on the piston electrode or the housing electrode.

According to some embodiments, the overvoltage protection circuit includes a voltage-switching/limiting component, and the fused SPD includes: a spark gap assembly, the spark gap assembly including a first spark gap electrode and a second spark gap electrode defining a spark gap therebetween; and a thermal disconnector mechanism positioned in a ready configuration, wherein the voltage-switching/limiting component is electrically connected in electrical series with the spark gap, the thermal disconnector mechanism being repositionable to electrically disconnect the voltage-switching/limiting component from the spark gap. The thermal disconnector mechanism includes: the first spark gap electrode; a voltage-switching/limiting component electrode electrically connecting the spark gap to the voltage-switching/limiting component; and a solder securing the first spark gap electrode in electrical connection with the voltage-switching/limiting component electrode in the ready configuration. The solder is meltable in response to overheating in the fused SPD. The thermal disconnector mechanism is configured to displace the first spark gap electrode away from the voltage-switching/limiting component electrode and thereby electrically disconnect the voltage-switching/limiting component from the spark gap when the solder is melted.

According to some embodiments, a surge protective device includes a voltage-switching/limiting component, a spark gap assembly, and a thermal disconnector mechanism. The spark gap assembly includes a first spark gap electrode and a second spark gap electrode defining a spark gap therebetween. The thermal disconnector mechanism is positioned in a ready configuration, wherein the voltage-switching/limiting component is electrically connected in electrical series with the spark gap. The thermal disconnector mechanism is repositionable to electrically disconnect the voltage-switching/limiting component from the spark gap. The thermal disconnector mechanism includes: the first spark gap electrode; a voltage-switching/limiting component electrode electrically connecting the spark gap to the voltage-switching/limiting component; and a solder securing the first spark gap electrode in electrical connection with the voltage-switching/limiting component electrode in the ready configuration. The solder is meltable in response to overheating in the surge protective device. The thermal disconnector mechanism is configured to displace the first spark gap electrode away from the voltage-switching/limiting component electrode and thereby electrically disconnect the voltage-switching/limiting component from the spark gap when the solder is melted.

In some embodiments, the spark gap is a horn spark gap.

### BRIEF DESCRIPTION OF THE DRAWINGS

The accompanying drawings, which form a part of the specification, illustrate embodiments of the present invention.

FIG. 1 is a block diagram that illustrates an electrical power supply circuit including a fused surge protective device (SPD) module in accordance with some embodiments.

FIG. 2 is a schematic view of a fused SPD circuit and module including an SGA fuse assembly in accordance with some embodiments.

FIG. 3 is an enlarged, fragmentary view of the SGA fuse assembly of FIG. 2 showing an SGA gap assembly forming a part of the SGA fuse assembly.

FIG. 4 is an enlarged, perspective view of a fuse element forming a part of the SGA fuse assembly of FIG. 2.

FIG. 5 is a perspective view of a semiconductive member forming a part of the SGA fuse assembly of FIG. 2.

FIG. 6 is a cross-sectional view of an overvoltage protection circuit forming a part of the fused SPD module of FIG. 1.

FIG. 7 is a fragmentary view of an SGA fuse assembly according to further embodiments.

FIG. 8 is a schematic view of a fused SPD circuit and module including an SGA fuse assembly in accordance with further embodiments.

FIG. 9 is a fragmentary, perspective view of the fused SPD circuit and module of FIG. 8.

FIG. 10 is a schematic view of a fused SPD circuit and module including an SGA fuse assembly in accordance with further embodiments in a ready position.

FIG. 11 is a schematic view of the fused SPD circuit and module of FIG. 10 in a first open circuit position.

FIG. 12 is a schematic view of the fused SPD circuit and module of FIG. 10 in a second open circuit position.

FIG. 13 is a schematic view of a fused SPD circuit and module in accordance with further embodiments.

FIG. 14 is a side view of a bimetallic fuse element according to some embodiments.

FIG. 15 is a side view of the bimetallic fuse element of FIG. 14 in an open or broken condition.

FIG. 16 is a schematic view of a fused SPD circuit and module in accordance with further embodiments.

FIG. 17 is a perspective view of the fused SPD circuit and module of FIG. 16.

FIG. 18 is a perspective view of a fused SPD module according to some embodiments.

FIG. 19 is a fragmentary, perspective view of the fused SPD module of FIG. 18.

FIG. 20 is a fragmentary, perspective view of the fused SPD module of FIG. 18.

FIG. 21 is a fragmentary, side view of the fused SPD module of FIG. 18.

FIG. 22 is an enlarged, fragmentary, perspective view of the fused SPD module of FIG. 18.

FIG. 23 is an enlarged, fragmentary, cross-sectional view of the fused SPD module of FIG. 18 taken along the line 23-23 of FIG. 20.

FIG. 24 is a schematic view of the fused SPD module of FIG. 18 illustrating operation of the fused SPD module in response to a surge current event.

FIG. 25 is a schematic view of the fused SPD module of FIG. 18 illustrating operation of the fused SPD module in response to a high fault current event.

FIG. 26 is a schematic view of the fused SPD module of FIG. 18 illustrating operation of the fused SPD module in response to a high fault current event.

FIG. 27 is a fragmentary, side view of the fused SPD module of FIG. 18 illustrating operation of the fused SPD module in response to a low fault current event.

FIG. 28 is a perspective view of an SPD module according to some embodiments.

FIG. 29 is a fragmentary, perspective view of the fused SPD module of FIG. 28.

FIG. 30 is a fragmentary, perspective view of the fused SPD module of FIG. 28.

FIG. 31 is a fragmentary, side view of the fused SPD module of FIG. 28.

FIG. 32 is an enlarged, fragmentary, side view of the fused SPD module of FIG. 28.

FIG. 33 is a fragmentary, side view of the fused SPD module of FIG. 28 illustrating operation of the fused SPD module in response to a high fault current event.

FIG. 34 is a fragmentary, side view of the fused SPD module of FIG. 28 illustrating operation of the fused SPD module in response to a low fault current event.

FIG. 35 is an exploded, perspective view of an SGA fuse assembly according to some embodiments.

FIG. 36 is a fragmentary, side of the SGA fuse assembly of FIG. 35.

FIG. 37 is a perspective view of a fused SPD module and a base according to some embodiments.

FIG. 38 is a fragmentary, perspective view of the fused SPD module and base of FIG. 37.

FIG. 39 is a perspective view of a fused SPD module according to some embodiments.

FIG. 40 is an exploded, perspective view of the fused SPD module of FIG. 39.

FIG. 41 is an exploded, perspective view of the fused SPD module of FIG. 39.

FIG. 42 is a fragmentary, perspective view of the fused SPD module of FIG. 39.

FIG. 43 is a fragmentary, perspective view of the fused SPD module of FIG. 39.

FIG. 44 is a perspective view of a fused SPD module according to some embodiments.

FIG. 45 is an enlarged, fragmentary, cross-sectional view of the fused SPD module of FIG. 44 taken along the line 45-45 of FIG. 44.

FIG. 46 is an exploded, perspective view of an SGA fuse assembly forming a part of the fused SPD module of FIG. 44.

FIG. 47 is fragmentary, top view of the SGA fuse assembly of FIG. 44.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It is noted that aspects described with respect to one embodiment may be incorporated in different embodiments although not specifically described relative thereto. That is, all embodiments and/or features of any embodiments can be implemented separately or combined in any way and/or combination. Moreover, other apparatus, methods, and systems according to embodiments of the inventive concept will be or become apparent to one with skill in the art upon review of the following drawings and detailed description. It is intended that all such additional apparatus, methods, and/or systems be included within this description, be within the scope of the present inventive subject matter, and be protected by the accompanying claims.

As used herein, “monolithic” means an object that is a single, unitary piece formed or composed of a material without joints or seams. Alternatively, a unitary object can be a composition composed of multiple parts or components secured together at joints or seams.

Some embodiments of the inventive concept stem from a realization that fuses used to protect surge protective devices (SPDs) from short circuit currents when they fail by disconnecting them from the circuit have generally very high current ratings. These high current ratings may allow the fuses to handle high impulse voltages and/or impulse currents from overvoltage events, such as lightning strikes, when configured in series with the SPD between the power line and ground or handle ongoing current when provided inline in the power line. The fuse must also safely disconnect short-circuit (fault) currents. In an AC system, the combined effects of the disintegration of the fusible element (contained in an arc-extinguishing media) and the zero-crossing of the mains voltage may enable successful fault current breaking. However, in DC systems, the absence of zero-crossing mains voltage often prevents the successful disconnection of standard fuses having electrically continuous fusible element(s). As a result, the fault current may be forced through the fuse in a high resistive state. This behavior can gradually thermically overstress the fuse, resulting in a rupture and arcing outside of the fuse's insulating body.

According to some embodiments of the inventive concept, a semiconductive gap-assisted (SGA) fuse element includes at least one fuse element and a semiconductive gap assembly. Each fuse element is electrically conductive and configured to melt or disintegrate in response to a sufficient amount of current. The semiconductive gap assembly includes two opposing gap electrodes and a semiconductive member. The gap electrodes are spaced apart by a trigger gap. The semiconductive member is interposed in electrical series between the two gap electrodes. In some embodiments, the semiconductive member is in contact with each of the two gap electrodes. In some embodiments, the gap electrodes and the semiconductive member form a unitary assembly. In some embodiments, the fuse element(s) and the semiconductive member form a unitary assembly.

In some embodiments, at least one of the gap electrodes is an end of one of the fuse elements. In some embodiments, the SGA fuse element includes first and second fuse elements, the first gap electrode is an end of the first fuse element, and the second gap electrode is an end of the second fuse element.

According to some embodiments of the inventive concept, an SGA fuse assembly or device includes an SGA fuse element as described above, first and second fuse device terminals electrically connected to opposed ends of the SGA fuse element, and a device housing containing the SGA fuse element.

In some embodiments, the SGA fuse assembly includes an electric arc extinguishing agent, such as SiO2, to terminate arcing along the fuse element(s). The SiO2 may be provided in the form of sand or powder.

According to some embodiments of the inventive concept, an overvoltage protection circuit may be connected in series with a semiconductive gap-assisted (SGA) fuse element as described above to form, in combination, a fused SPD circuit. In some embodiments, the fused SPD circuit is provided in the form of a fused SPD unit or module, wherein the overvoltage protection circuit and the SGA fuse element are each integrated in the fused SPD unit or module.

The fused SPD circuit may include a thermal disconnector device along with the overvoltage protection circuit and the SGA fuse element. In some embodiments, the thermal disconnector device is integrated in the fused SPD unit or module along with the overvoltage protection circuit and the SGA fuse element.

The overvoltage protection circuit of the fused SPD circuit may include one or more active voltage-switching/limiting components, such as a varistor or gas discharge tube.

The SGA fuse assembly may be configured to electrically open the circuit through melting or disintegration of the fuse element(s) within a specified time period in response to a minimum short circuit current received therethrough from the overvoltage protection circuit (referred to herein as the “minimum SPD short circuit current”). For example, in a power line application, the minimum SPD short circuit current expected through the overvoltage protection circuit may be in a range from 300 A-1000 A. A standard for protecting SPDs from short circuit current events may be that the SPD be disconnected from the circuit within 5 seconds of the SPD short circuit current event. Thus, when used in the example power line application, the SGA fuse assembly may be configured such that the fuse element(s) melt or disintegrate within 5 seconds to open the circuit in response to an SPD short circuit current of at least 300 A.

The SGA fuse assembly may also be configured to handle very large SPD surge impulse currents that are generated due to overvoltage or current surge events, such as lightning strikes. An SPD may be required to re-direct a surge impulse current of up to 25 kA, which lasts between 1 ms to 5 ms, to ground. The SGA fuse assembly, according to some embodiments of the inventive concept, may conduct such high currents for up to 5 ms without the fuse element(s) melting or disintegrating to open the circuit.

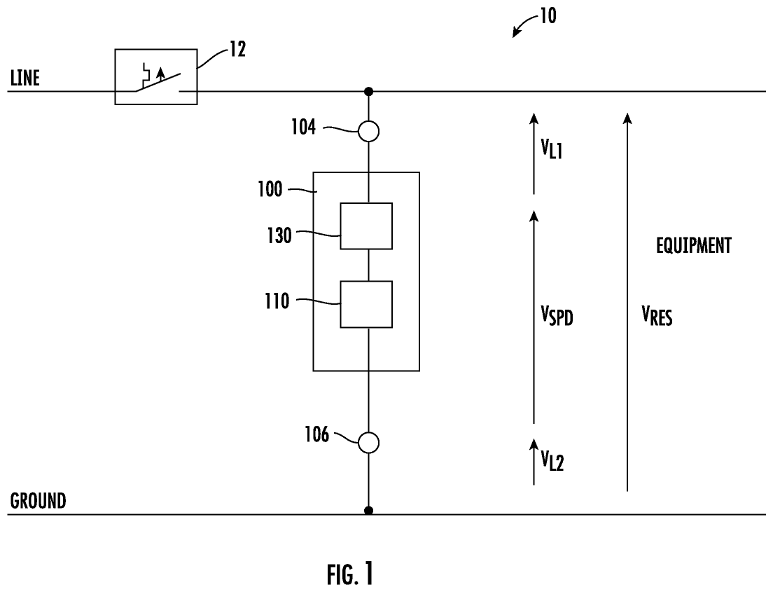

With reference to FIGS. 1-5, an SGA fuse device or assembly 130 according to some embodiments is shown therein. The SGA fuse assembly 130 includes an SGA fuse element assembly 140 according to some embodiments.

In some embodiments, the SGA fuse assembly 130 is integrated into a fused surge protective device (SPD) unit or module 100 including an overvoltage protection circuit (OPC) 110. In this case, the SGA fuse assembly 130 operates as an integrated backup fuse. In other embodiments, the SGA fuse assembly 130 may be provided, installed and used as an individual component in a protection circuit of a power supply circuit (e.g., not physically integrated in a module with the OPC 110).

In some embodiments, the SGA fuse assembly 130 or the fused SPD module 100 are provided, installed and used as a component in a protection circuit of a power supply circuit 10 as shown in FIG. 1, for example. In the power supply circuit 10, the OPC 110 is in electrical series with the SGA fuse assembly 130, and the OPC 110 and the SGA fuse assembly 130 are in electrical parallel across sensitive equipment. The fused SPD module 100 is designed to protect the sensitive equipment from overvoltages and current surges. The fused SPD module 100 may also be connected to the power source via an upstream second fuse or circuit breaker 12.

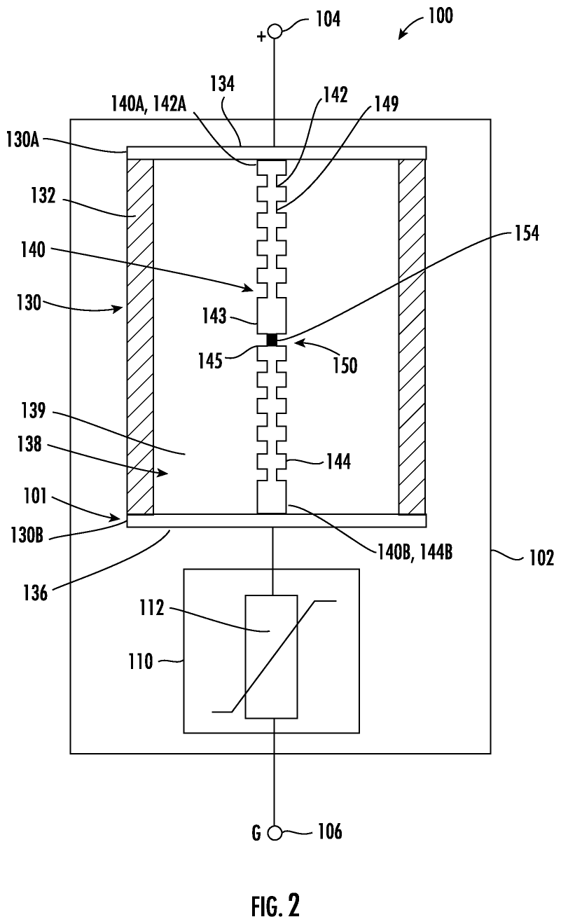

With reference to FIG. 2, the fused SPD module 100 includes the fuse assembly 130, a module housing 102, a first electrical terminal 104, a second electrical terminal 106, and the OPC 110. The SGA fuse assembly 130 and the OPC 110 are disposed in the housing 102, and are electrically connected between the terminals 104 and 106 to form a fused SPD electrical circuit 101.

As mentioned above, in other embodiments the SGA fuse assembly 130 and the OPC 110 are not combined in a module. It will be appreciated that the discussion herein regarding the construction and operation of the fused SPD module 100 likewise applies to the fused SPD electrical circuit 101 in such embodiments.

The OPC 110 may be any suitable overvoltage protection circuit. In some embodiments, the OPC 110 includes an active voltage-switching or active voltage limiting component (referred to herein as a “voltage-switching/limiting component) 112.

In some embodiments, the OPC 110 is a varistor-based overvoltage protection circuit and the voltage-switching/limiting component 112 is a varistor. In some embodiments, the voltage-switching/limiting component 112 is a metal oxide varistor (MOV). the voltage-switching/limiting component 112. For example, in some embodiments the OPC 110 is a varistor-based SPD as disclosed in U.S. Pat. No. 8,743,525 to Xepapas et al., the disclosure of which is incorporated herein by reference.

In some embodiments, the voltage-switching/limiting component 112 is a spark gap. In some embodiments, the voltage-switching/limiting component 112 is a gas discharge tube (GDT). In some embodiments, the voltage-switching/limiting component 112 is diode. In some embodiments, the voltage-switching/limiting component 112 is a thyristor.

The voltage-switching/limiting component 112 may also be another type of voltage-switching/limiting surge protective device. Other types of voltage-switching/limiting component 112 that may form, or form a part of, the OPC 110 may include spark gap devices, multi-cell GDTs (e.g., as disclosed in U.S. Pat. No. 10,685,805 to Rozman and U.S. Pat. No. 10,186,842 to Rozman, the disclosures of which are incorporated herein by reference), diodes, or thyristors.

The OPC 110 may include or consist of only a single voltage-switching/limiting component 112. In some embodiments, the OPC 110 includes or consists of only the active voltage-switching/limiting component(s) 112 and associated electrical connections, if any.

The OPC 110 may include a plurality of voltage-switching/limiting components 112. The OPC 110 may include one or more voltage-switching/limiting components 110 in combination with other electrical components. In some embodiments, the OPC 110 includes multiple varistors (connected in electrical parallel or series between the module terminals), multiple GDTs (e.g., connected in electrical series), and/or both varistor(s) and GDT(s) (e.g., connected in electrical series with the varistor(s)), and/or other circuit elements, such as resistors, inductors, or capacitors.

With reference to FIGS. 2-4, the SGA fuse assembly 130 has a first end 130A and an opposing second end 130B. The SGA fuse assembly 130 includes a fuse assembly housing 132, a first terminal 134 (at the end 130A), a second terminal 136 (at the end 130B), an electric arc extinguishing agent 139, and an SGA fuse element assembly 140. The housing 132 and the terminals 134, 136 define a chamber 138.

The housing 132 may be formed of any suitable electrically insulating material. In some embodiments, the housing 132 is formed of ceramic.

The terminals 134, 136 may be formed of any suitable electrically conductive metal. In some embodiments, the terminals 134, 136 are formed of copper, brass, stainless steel, aluminum copper (AlCu) or tungsten copper (WCu). The terminals 134, 136 may be formed of a base metal as stated above with additional surface plating (galvanization) of nickel or tin.

The electric arc extinguishing agent 139 may be formed of any suitable material. In some embodiments, the arc extinguishing agent 139 is a flowable media. In some embodiments, the arc extinguishing agent is flowable granules. In some embodiments, the electric arc extinguishing agent 139 is silica granules (silicon dioxide). The granule size and packing may be selected to optimize the performance of the extinguishing agent 139 as described herein.

The SGA fuse element assembly 140 has a first end 140A and an opposing second end 140B. The SGA fuse element assembly 140 includes a first fuse element 142, a second fuse element 144, and a semiconductive gap assembly 150. The SGA fuse element 140 is disposed in the chamber 138. The SGA fuse element assembly 140 is generally surrounded by the extinguishing agent 139 that fills the chamber 138.

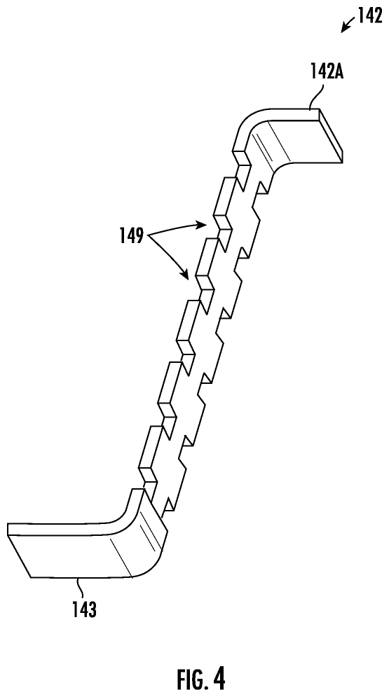

The first fuse element 142 is elongate and extends from an outer terminal end 142A to an internal end 143, which serves as a first gap electrode. The second fuse element 144 is elongate and extends from an outer terminal end 144A to an internal end 145, which serves as a second gap electrode. Holes and/or cutouts may be defined in the fuse elements 142, 144 to form constrictions 149 therein as shown in FIG. 4.

The fuse elements 142, 144 are each formed of a fusible material that will melt or disintegrate when subjected to a current energy. In some embodiments, the fuse elements 142, 144 are formed of a material or materials selected from the group consisting of nickel, iron, copper, chromium, and silver. In some embodiments, the fuse elements 142, 144 are formed of a material or materials having a specific electrical resistance in the range of 1×10⁻⁸ to 1×10⁻⁶ [Ωm].

In some embodiments, one or both fuse elements 142, 144 are bimetallic fuse elements as described in more detail below.

In further embodiments, the SGA fuse element assembly 140 may include fuse elements 142 and/or 144 that are arranged in electrical parallel. In some embodiments, the SGA fuse element assembly 140 may include only one of the fuse elements 142, 144.

In further embodiments, the fuse elements 142, 144 may be formed of bimetallic material. For example, each fuse element 142, 144 may include a first fusible layer of a first metal laminated to a second fusible layer of a second metal different from the first metal.

With reference to FIG. 4, the semiconductive gap assembly 150 includes the first gap electrode 143, the second gap electrode 145, a semiconductive or trigger gap 152, and a semiconductive member 154. The trigger gap 152 is defined by and between the opposing gap electrodes 143 and 145. The semiconductive member 154 is positioned in the trigger gap 152 and interposed between the gap electrodes 143 and 145. The semiconductive member 154 is connected in electrical series between the fuse elements 142 and 144.

The semiconductive member 154 has a body 156A and an exterior surface 156B. The semiconductive member 154 extends from a first end face 158A to an opposing second end face 158B. In some embodiments and as illustrated, the first end face 158A is in electrical contact with the first gap electrode 143, and the second end face 158B is in electrical contact with the second gap electrode 145.

The semiconductive member 154 may be formed of any suitable semiconductive material. In some embodiments, the semiconductive member 154 is formed of a composition including a mixture of a polymeric material (e.g., a rubber or a plastic) as a nonconductive matrix and an electrically conductive filler. In some embodiments, the conductive filler is graphite powder. In some embodiments, the conductive filler is expanded graphite powder.

The conductive filler may be a material other than graphite powder having a relatively high secondary emission, such as beryllium oxide (BeO), magnesium oxide (MgO), or gallium phosphide (GaP).

The semiconductive member 154 can be rigid or flexible depending on the polymer matrix. In some embodiments, the semiconductive member 154 has a porous structure.

In some embodiments, the semiconductive member 154 is formed of a semiconductive ceramic. In some embodiments, the semiconductive member 154 is formed of ZnO (zinc oxide) or BaTiO3 (Barium titanate) or SiC (silicon carbide), with different dopants (oxides, metals).

The gap electrodes 143, 145 and the semiconductive member 154 define gap open regions or volumes VO in the trigger gap 152 around the semiconductive member 154 (i.e., around the volume VM of the trigger gap 152 filled or occupied by the semiconductive member 154). Opposed regions 143A, 145A of the gap electrodes 143, 145 are exposed (i.e., are not covered by the semiconductive member 154).

In some embodiments, the gap spacing distance H1 between the gap electrodes 143, 145 in the gap open volumes VO is at least 1 mm. In some embodiments, the gap spacing distance H1 is in the range of from about 0.2 mm to 2 mm.

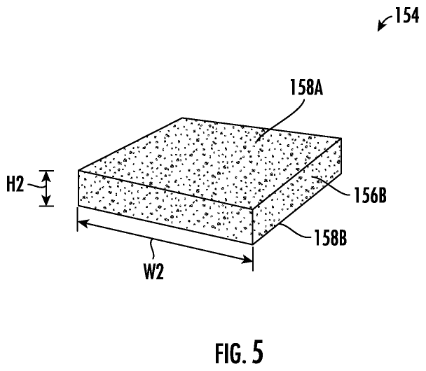

Referring to FIG. 5, in some embodiments, the thickness or height H2 of the semiconductive member 154 is at least 1 mm. In some embodiments, the height H2 is in the range of from about 0.2 mm to 2 mm. In some embodiments, the height H2 is substantially the same as the gap spacing distance H1.

In some embodiments, the width W1 of the trigger gap 152 is at least 5 mm. In some embodiments, the width W1 is in the range of from about 2 mm to 20 mm.

In some embodiments, the width W2 of the semiconductive member 154 is in the range of from about 10 to 100 percent of the width W1.

The SGA fuse assembly 130 and the fused SPD assembly 100 may operate as follows in service.

According to some embodiments of the inventive concept, the fused SPD module 100 is configured to operate under four different conditions:
1) normal (stand by) operation;
2) an overvoltage or current surge event in which the fused SPD module 100 is designed to shunt an SPD surge impulse current to ground;
3) a high short circuit (fault) event; and
4) a low short circuit (fault) event.

The fused SPD module 100 is designed to shunt an SPD surge impulse current to ground in response to an overvoltage or current surge event.

A high short circuit (fault) event (condition 3)) may occur when the voltage-switching/limiting component 112 of the OPC 110 degrades at the end of its lifecycle and begins acting or operating as a short circuit. A high short circuit (fault) event (condition 3)) may also occur when a fail-safe mechanism of the OPC 110 is actuated to short-circuit the voltage-switching/limiting component 112.

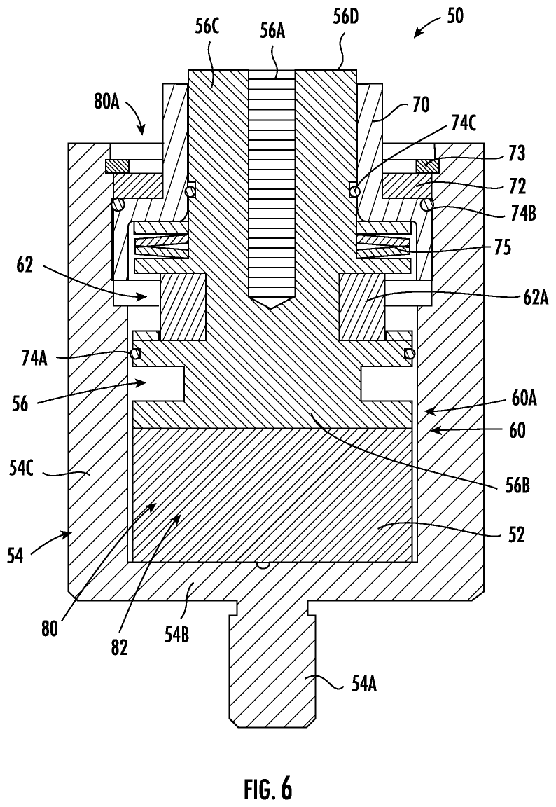

FIG. 6 shows an example OPC module 50 that is used as the OPC 110 in accordance with some embodiments. The OPC module 50 may be constructed and operate, for example, as disclosed in U.S. Pat. No. 8,743,525 to Xepapas et al.), the disclosure of which is incorporated herein by reference.

The illustrated OPC module 50 includes a housing or housing assembly 51, a voltage-switching/limiting component 52 (e.g., a varistor), a first fail-safe mechanism 60, a second fail-safe mechanism 62, an electrically insulating member 70, an end cap 72, a clip 73, an O-ring 74A, an O-ring 74B, an O-ring 74C, and one or more biasing devices in the form of loading springs 75 (e.g., spring washers).

In some embodiments, the voltage-switching/limiting component 52 is a varistor wafer and, in some embodiments, is an MOV.

Either or both of the fail-safe mechanisms 60, 62 may be automatically actuated to short-circuit the voltage-switching/limiting component 52 (e.g., a varistor) under appropriate conditions.

The housing assembly 51 includes a metal first or housing electrode 54 and a metal second or piston electrode 56.

The housing electrode 54 is a cup-shaped metallic structure. The housing electrode 54 has an end or electrode wall 54B and an integral tubular, cylindrical side wall 54C extending from the end wall 54B. The side wall 54C and the end wall 54B form a chamber or cavity 80 communicating with an opening 80A. An integral threaded terminal post 54A projects axially outwardly from the end wall 54B for electrically connecting an input or output electrical line. The end wall 54B has an inwardly facing, substantially planar contact surface.

According to some embodiments, the housing electrode 54 is formed of aluminum. However, any suitable electrically conductive metal may be used. According to some embodiments, the housing electrode 54 is unitary and, in some embodiments, monolithic.

The piston electrode 56 has a head 56B disposed in the cavity 80 and an integral shaft 56C that projects outwardly through the opening 80A. The varistor wafer 52 is disposed in the cavity 80 between and in contact with each of the electrode wall 54B and the head 56B. The shaft 56C has a terminal end face 56D. An integral threaded bore 56A is provided in the end of the shaft 56C for electrically connecting an input or output electrical line.

According to some embodiments, the piston electrode 56 is formed of aluminum. However, any suitable electrically conductive metal may be used. According to some embodiments, the piston electrode 56 is unitary and, in some embodiments, monolithic.

The components 54, 56, 70, 72, 73, 74A, 74B, 74C, collectively form a housing assembly 51 defining a sealed, enclosed chamber 82. The varistor 52 is disposed axially between the housing electrode 54 and the piston electrode 56 along a lengthwise axis in the enclosed chamber 82.

When the OPC module 50 is assembled as shown in FIG. 6, the springs 75 are resiliently deflected and thereby persistently load the head 56B. In this way, the varistor wafer 52 is clamped between the head 56B and the electrode wall 54B.

It will be appreciated that, when an overvoltage or current surge event (e.g., a transient power surge) applies a surge impulse current to the OPC module 50, the varistor 52 will temporarily go to a low impedance state (e.g., effectively becoming a short circuit) and the OPC module 50 will become a short circuit from the electrode post 54A to the electrode shaft 56C.

The first fail-safe mechanism 60 can be triggered when the varistor 52 fails as a short circuit. In this case, arcing will occur adjacent and within a short circuit failure site in the varistor 52 (i.e., the arc is initiated at the varistor 52) and propagate or occur directly between the outer peripheral side wall of the piston electrode 56 and the adjacent interior surface of the housing electrode 54. This arcing causes a metal surface portion of the piston electrode 56 and a metal surface portion of the housing electrode 54 to fuse or bond directly to one another in a prescribed region at a bonding or fusing site in a fusing region 60A to form a bonded or fused interface portion. The fusing or bonding may occur by welding induced by the arc. In this way, the electrodes 54, 56 are shorted at the interface to bypass the varistor 52 so that the current induced heating of the failed varistor 52 ceases.

The second fail-safe mechanism 62 includes an electrically conductive metal meltable member 62A. When heated to a threshold temperature, the meltable member 62A will flow to bridge and electrically connect the electrodes 54, 56. The meltable member 62A thereby redirects the current applied to the OPC module 50 to bypass the varistor 52 so that current induced heating of the varistor 52 ceases.

The fail-safe mechanisms 60, 62 may thereby serve to prevent or inhibit thermal runaway and catastrophic failure of the OPC module 50.

A low short circuit (fault) event (condition 4)) may be, for example, an ambient leakage current event associated with the OPC 110 (e.g., associated with diode junctions of a varistor 112 of the OPC 110). The low fault current may be the result of a varistor in end of life state with impedance that is not very low, and/or a low prospective current (maximum short circuit amplitude) at the point of installation of the fused SPD device 100. A low short circuit (fault) event (condition 4)) may also occur when a fail-safe mechanism of the OPC 110 (e.g., the OPC 50 as described above) is actuated to short-circuit the voltage-switching/limiting component 112.

The SGA fuse assembly 130 is configured to operate in three alternative modes: 1) a standby mode; 2) a surge current mode; and 3) a high short circuit (fault) current mode. As discussed below, these three modes may correspond to the first three conditions of the fused SPD assembly 100 listed above.

The semiconductive gap assembly 150 has a prescribed threshold flashover voltage. When a voltage is applied across the gap electrodes 143, 145 that is less than the threshold flashover voltage, the applied voltage will not initiate arc flashover between the gap electrodes 143, 145. As discussed below, when a voltage is applied across the gap electrodes 143, 145 that is greater than or equal to the threshold flashover voltage, the applied voltage will initiate arc flashover between the gap electrodes 143, 145.

The SGA fuse assembly 130 is constructed and installed with the fuse assembly 130 in the configuration shown in FIG. 2. The electrodes 134 and 136 are electrically connected by the SGA fuse element assembly 140, which makes electrical contact with the electrodes 134 and 136 via the fuse ends 142A and 144A, respectively. The terminal 104 is electrically connected to the Line (L) of the circuit 10, and the terminal 106 is electrically connected to the Ground (G) of the circuit 10 (FIG. 1).

During normal operation, the OPC 110 practically acts as an insulator. The voltage applied across the semiconductive gap assembly 150 is insufficient to initiate a spark across the semiconductive gap assembly 150. The SGA fuse assembly 130 remains in the configuration shown in FIG. 2 and no current is conducted through the SGA fuse element assembly 140.

When an overvoltage or current surge event (e.g., a transient power surge) applies a surge impulse current to the fused SPD circuit 101, the OPC 110 will temporarily go to a low impedance state (e.g., effectively becoming a short circuit), and the SGA fuse assembly 130 is supplied with an SPD surge impulse current. The voltage-switching/limiting component 112 (e.g., varistor or GDT) of the OPC 110 is designed to shunt the surge impulse current associated with such events to ground to protect sensitive equipment. The SPD surge impulse current may be on the order of tens of kA, but will typically last only a short duration (in the range of from about tens of microseconds to a few milliseconds).

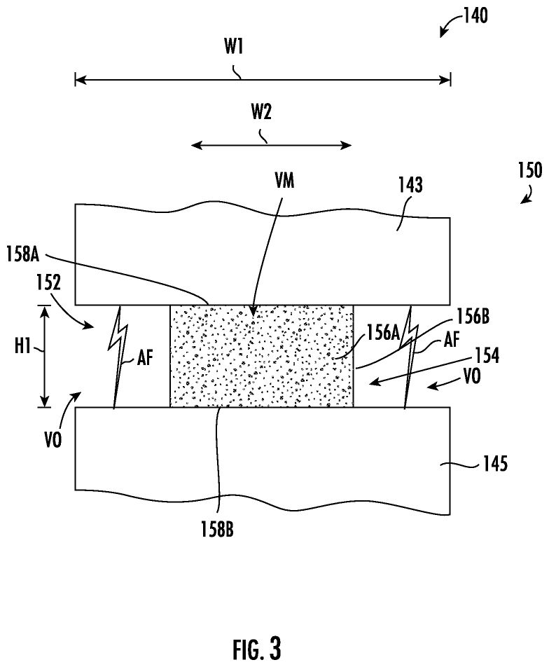

During the surge event, the voltage applied across the trigger gap 152 by the surge event exceeds the prescribed threshold flashover voltage of the semiconductive gap assembly 150. In response, the voltage across the semiconductive gap assembly 150 initiates electrical arc flashover AF (FIG. 3) across the trigger gap 152. That is, electrical arcing AF is generated between the gap electrodes 143 and 145. In some embodiments, the voltage applied across the trigger gap 152 by the surge event is essentially or nearly the same as the voltage across the terminals 134, 136 of the SGA fuse assembly 130.

The initiation of the flashover is assisted by the semiconductive member 154 in response to the overvoltage developed across the first gap electrode 143 and the second gap electrode 145. At the beginning of the surge current, current conduction occurs through the bulk of the semiconductive member body 156A and along the exterior surface 156B of the semiconductive member 154. Very quickly thereafter (e.g., within less than 1 microsecond), the flashover AF occurs so that most of the surge current is bypassed through the arc column(s) established between the gap electrodes 143, 145. By diverting the current around the semiconductive member 154, degradation of the semiconductive member 154 is prevented or reduced.

The surge current flows between the terminals through the fuse element 142, across the trigger gap 152, and through the fuse element 144. When the supplied surge current ceases, the voltage across the gap electrodes 143, 145 drops below the ignition voltage, the flashover ends and the SGA fuse assembly 130 stops conducting. The fused SPD module 100 may return to its standby mode.

The semiconductive member 154 functions as a spark gap trigger that assists in initiating the flashover between the gap electrodes 143, 145. Because the semiconductive member 154 is provided, the threshold flashover voltage of the semiconductive gap assembly 150 is less than the voltage that would be required to initiate the flashover across the trigger gap 152 in the absence of the semiconductive member 154 (i.e., if only the airgap 152 was provided). By reducing the minimum required flashover voltage, the semiconductive member 154 lowers the protection level of the fused SPD electrical circuit 101.

In some embodiments, the SGA fuse element assembly 140 is capable of conducting this SPD surge impulse current without disintegrating or significantly degrading the SGA fuse element assembly 140 (i.e., without disintegrating or significantly degrading the fuse elements 142, 144 or the semiconductive member 154). The SGA fuse assembly 130 remains in the configuration shown in FIG. 2. The SGA fuse assembly 130 therefore will not interrupt the SPD surge impulse current, and will remain usable for further operation.

Accordingly, the SGA fuse assembly 130 may be configured to carry the SPD surge impulse current therethrough without the SGA fuse element assembly 140 disintegrating to open the circuit. In some embodiments, the SGA fuse element assembly 140 and the fused SPD module 100 are designed to conduct and withstand multiple surges without failure (where “failure” means the device ruptures or is no longer capable of operating in the modes described herein).

In some embodiments of the inventive concept, the SGA fuse assembly 130 may be configured to carry therethrough an SPD surge impulse current of up to 25 kA for a time of up to 5 ms, a 25 kA 8/20 impulse waveform, and/or 25 kA 10/350 impulse waveform without the SGA fuse element assembly 140 disintegrating to open the circuit.

When a high short circuit event (condition 3) discussed above) occurs, the OPC 110 will supply the SGA fuse assembly 130 with a relatively high SPD short circuit current. In some instances, the OPC 110 assumes a low impedance state (e.g., an MOV thereof assumes an end of life state), which permits a high system fault current (referred to herein as a “high short circuit fault current”) to flow through the OPC 110 and the SGA fuse assembly 130. In some embodiments, this high short circuit fault current is in the range of from 1 kA to 20 kA.

During the high short circuit event, the voltage applied across the trigger gap 152 by the high short circuit event exceeds the prescribed threshold flashover voltage of the semiconductive gap assembly 150. In response, the voltage across the semiconductive gap assembly 150 initiates electrical arc flashover across the trigger gap 152. That is, electrical arcing AF is generated between the gap electrodes 143 and 145.

During the high short circuit event, the semiconductive member 154 functions as a spark gap trigger that assists in initiating the flashover between the gap electrodes 143, 145 in the same manner as described above for the surge current event operation. At the beginning of the fault current, current conduction occurs through the bulk of the semiconductive member body 156A and along the exterior surface 156B of the semiconductive member 154. Very quickly thereafter (e.g., within less than 1 microsecond), the flashover occurs so that the majority of the fault current is bypassed through the arc column(s) established between the gap electrodes 143, 145 across the trigger gap 152. By diverting the fault current around the semiconductive member 154, degradation of the semiconductive member 154 is prevented or reduced.

The arcing AF across the trigger gap 152 enables the fault current conducted through the SGA fuse assembly 130 to increase. The increased fault current melts one or both of the fuse elements 142, 144 at sections thereof. The melted fuse element material mixes with and is cooled by the arc extinguishing media 139. This creates high resistance sections along the fuse element(s) 142, 144. These high resistance sections may be conductive or semiconductive. The high resistance sections create voltage drops along the fuse element(s) 142, 144. These voltage drops add together and increasingly reduce the voltage across the semiconductive gap assembly 150 to relatively low values, until the voltage across the semiconductive gap assembly 150 is less than the ignition voltage necessary to sustain the arcing between the gap electrodes 143, 145. The voltage across the semiconductive gap assembly 150 is then also less than necessary to trigger flashover between the gap electrodes 143, 145 or to conduct current through or along the surface of the semiconductive member 154. That is, at this lower voltage, the semiconductive member 154 operates as an electrical insulator between the gap electrodes 143, 145. The SGA fuse assembly 130 is thereby opened at the semiconductive gap assembly 150 and the fault current through the SGA fuse assembly 130 and the fused SDP module 100 is cut off or interrupted.

The semiconductive gap assembly 150 serves to electrically open the SGA fuse element assembly 140 (and thereby the circuit between the fuse device terminals 134, 136) once the fuse element(s) 142, 144 have achieved a threshold amount of disintegration. Without the semiconductive gap assembly 150, the intact portions of the fuse elements 142, 144, the semiconductive fuse/media sections, and arcing between portions of the fuse elements 142, 144 may continue to support sufficient flow through current to enable the fault current to continue longer than desired. The semiconductive member 154 serves both to lower the threshold flashover voltage (to initiate fault current thought the SGA fuse element assembly 140) and to thereafter cut off the fault current to interrupt the fault current.

The threshold flashover voltage and the time are which flashover occurs are tuned or calibrated properties of the semiconductive gap assembly 150 that may be controlled by the dimensions of the trigger gap 152, the dimensions of the gap electrodes 143, 145, the dimensions of the semiconductive member 154, and the composition of the semiconductive member 154.

The threshold flashover voltage value is made low by making the separation distance between the gap electrodes 143, 145 relatively small (e.g., 0.2-5 mm). The threshold flashover voltage value is also made low by using expanded graphite powder to form the semiconductive member 154.

The SGA fuse assembly 130 may be particularly beneficial when used in a DC electrical system. In the case of AC systems, zero-crossing of mains voltage can assist in fault current breaking. In the case of a DC system, even when the fuse elements disintegrate and thereby increase the fuse resistance and reduce the fault current amplitude to relatively low values, the absence of mains zero-crossing continues to force current through the fuse in a high resistive state. This behavior can gradually thermically overstress the fuse, resulting in explosion and arcing outside the insulating body of the fuse.

As mentioned above, the melted fuse element material mixes with the arc extinguishing media 139 to create fuse/media mixture sections. The electrical conductivity of these fuse/media sections depends on their temperature. When hot, the fuse/media mixture sections are more electrically conductive. Because DC systems lack zero crossing, the mixtures cannot be rapidly cooled by as may occur with AC systems.

In some embodiments, the SGA fuse assembly 130 is primarily provided open quickly to prevent overheating of the OPC 110. The threshold flashover voltage of the semiconductive gap assembly 150 is set relatively low, so that the clamping voltage of the fused SPD device 100 is not significantly greater than the clamping voltage of the OPC 110 alone. In some embodiments, the OPC 110 includes a fail-safe mechanism that short circuits the voltage-switching/limiting component 112 (e.g., a varistor) in response to overheating of the voltage-switching/limiting component 112. In some embodiments, the short-circuiting fail-safe mechanism melts a meltable member or arc welds adjacent electrodes responsive to overheating, as disclosed in U.S. Pat. No. 8,743,525 to Xepapas et al., the disclosure of which is incorporated herein by reference.

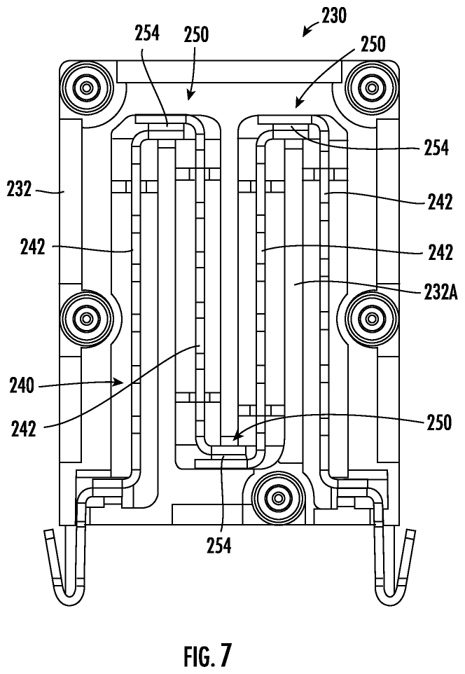

SGA fuse assemblies as disclosed herein may include multiple semiconductive gap assemblies and/or may have a meandric shape to increase the effective length of the fuse. For example, with reference to FIG. 7, an SGA fuse assembly 230 according to further embodiments is shown therein. The SGA fuse assembly 230 may be used and constructed in the same manner as the SGA fuse assembly 130, except as follows. The SGA fuse assembly 230 may be used in place of the SGA fuse assembly 130 in the fused SPD device 100 or circuit 101, for example.

The SGA fuse assembly 230 includes an electrically insulating module housing 232, electrically insulating partition walls 232A, and an SGA fuse element assembly 240. The SGA fuse element assembly 240 differs from the SGA fuse element assembly 140 in that the SGA fuse element assembly 240 includes four fuse elements 242, three semiconductive members 254, and three SGA gap assemblies 250 corresponding to the fuse elements 142, 144, the semiconductive member 154, and the SGA gap assembly 150, respectively.

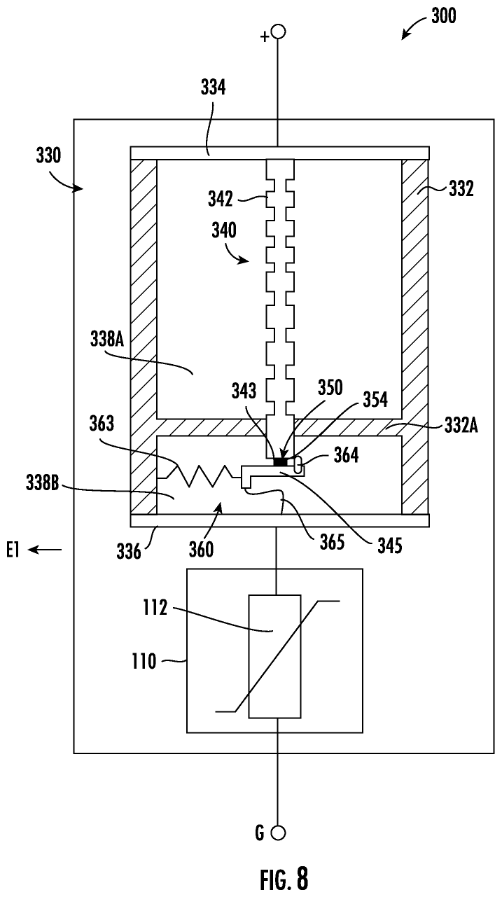

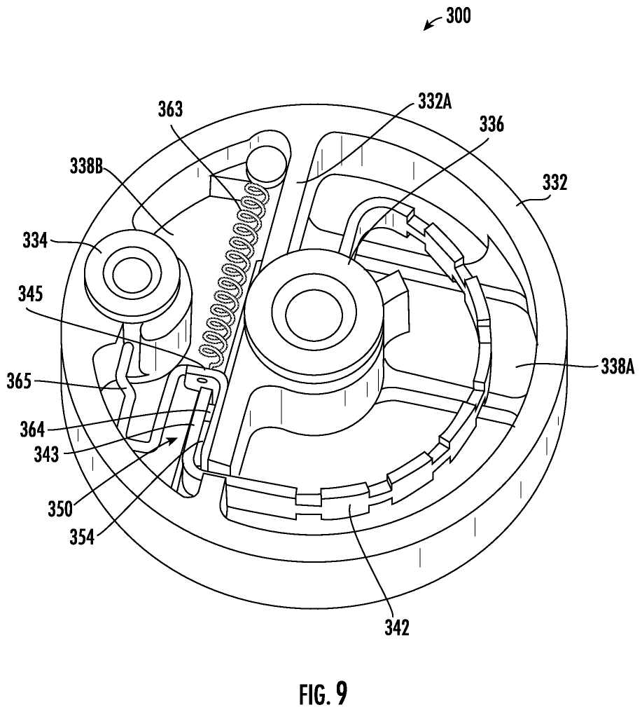

With reference to FIGS. 8 and 9, a fused SPD module 300 according to further embodiments is shown therein. The fused SPD module 300 includes an SGA fuse assembly 330 and may be used and constructed in the same manner as the fused SPD module 100, except as follows. FIG. 8 is a schematic view of the fused SPD module 300. FIG. 9 is a fragmentary, perspective view of the SGA fuse assembly 330.

The SGA fuse assembly 330 is configured to operate in the same manner as the SGA fuse assembly 130 in response to surge current events and high short circuit (fault) currents. The SGA fuse assembly 330 further includes a thermally-actuated disconnect mechanism 360 to interrupt a low short circuit (fault) current in the case of a low short circuit (fault) current event.

The SGA fuse assembly 330 includes a first terminal 334, a second terminal 336, a module housing 332 and a partition wall 332A that define a fuse chamber 338A and a disconnect chamber 338B. The SGA fuse assembly 330 further includes an SGA fuse element assembly 340 and the disconnect mechanism 360.

The SGA fuse element assembly 340 includes a fuse element 342 and a semiconductive gap assembly 350. The fuse element 342 may be constructed the same as the fuse element 142. The semiconductive gap assembly 350 includes a semiconductive or trigger gap 352, a first gap electrode 343, a second gap electrode 345, and a semiconductive member 354 corresponding to the trigger gap 152, the gap electrode 143, the gap electrode 145, and the semiconductive member 154, respectively. The first gap electrode 343 is an end of the fuse element 342. The second gap electrode 345 is a movable contact forming a part of the disconnect mechanism 360.

The disconnect mechanism 360 includes the movable contact 345, a loading or biasing device (e.g., a spring) 363, a meltable retainer or element 364, and a flexible conductor 365.

The trigger gap 352 is defined by and between the opposing gap electrodes 343 and 345. The semiconductive member 354 is positioned in the gap 352 and interposed between the gap electrodes 343 and 345. The semiconductive member 354 is connected in electrical series between the fuse elements 342 and the movable contact 345. In some embodiments and as illustrated, the opposed end faces of the semiconductive member 354 are each in electrical contact with a respective one of the gap electrodes 343, 345.

The movable contact 345 is electrically connected to the terminal 336 by the flexible conductor 365. The spring 363 loads, biases or pulls the movable contact 345 in a disconnect direction E1. The meltable element 364 holds the movable contact 345 in position relative to the gap electrode 343 against the load the spring 363.

The SGA fuse assembly 330 is configured to respond to surge current events and high short circuit events in the same manner as described for the SGA fuse assembly 130, except that the movable contact 345 serves as the second gap electrode in place of the gap electrode 145.

When a low short circuit event (condition 4) discussed above) occurs, the OPC 110 will supply the SGA fuse assembly 330 with a relatively low SPD short circuit current. In some instances, the OPC 110 assumes a moderately low impedance state (e.g., an MOV thereof assumes an end of life state), which permits a low system fault current or leakage current (referred to herein as a “low short circuit fault current”) to flow through the OPC 110 and the SGA fuse assembly 330. In some embodiments, this low short circuit fault current is in the range of from 1 A to 100 A.

During the low short circuit event, the voltage applied across the semiconductive gap assembly 350 by the low short circuit event exceeds the prescribed threshold flashover voltage of the semiconductive gap assembly 350. In response, the voltage across the semiconductive gap assembly 350 initiates electrical arc flashover across the trigger gap 352. That is, electrical arcing is generated between the gap electrodes 343 and 345.

During the low short circuit event, the semiconductive member 354 functions as a spark gap trigger that assists in initiating the flashover between the gap electrodes 343, 345 in the same manner as described above for the semiconductive member 154. At the beginning of the fault current, current conduction occurs through the bulk of the semiconductive member body and along the exterior surface of the semiconductive member 354. Very quickly thereafter (e.g., within less than 1 microsecond), the flashover occurs so that the majority of the fault current is bypassed through the arc column(s) established between the gap electrodes 343, 345.

The low short circuit fault current then conducted through the SGA fuse element assembly 340 is insufficient to interrupt the current in the manner described above for a high short circuit fault current (i.e., by disintegrating the fuse element). Instead, the heat generated by the arcing across the semiconductive gap assembly 350 is conducted to the meltable element 364, which causes the meltable element 364 to melt (e.g., soften). The melting of the meltable element 364 permits the spring 363 to displace or pull the gap electrode (movable contact) 345 away from the gap electrode 343, thereby disconnecting the terminal 336 of the SGA fuse device 330 from the fuse element 342. The fault current is thereby interrupted.

In some embodiments, the SGA fuse device 330 is mechanically secured directly to the end of an OPC module such as the OPC module 50 (FIG. 6). The SGA fuse device 330 may be connected to the OPC module 50 by a fastener (e.g., bolt) that extends through a hole in the terminal 336 and is threaded into the bore 56A. A power line may be secured to the terminal 334.

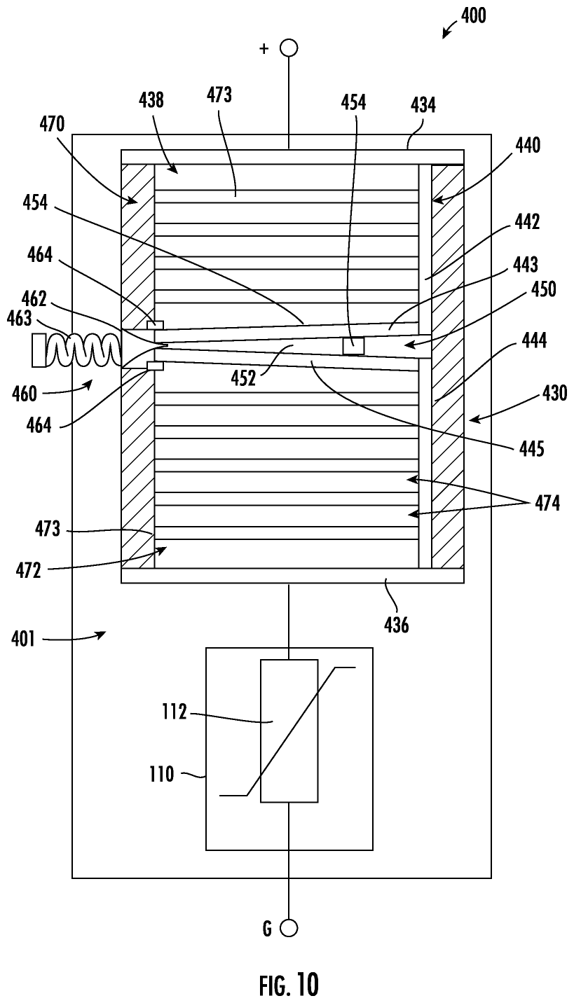

With reference to FIGS. 10-12, a fused SPD module 400 according to further embodiments is shown therein. The fused SPD module 400 includes an SGA fuse assembly 430 and may be used and constructed in the same manner as the fused SPD module 300, except as follows.

The SGA fuse assembly 430 includes a first terminal electrode 434, a second terminal electrode 436, a chamber 438, an SGA fuse element assembly 440, and a thermally-actuated disconnect mechanism 460.

The SGA fuse element assembly 440 includes a first fuse element 442, a second fuse element 444, a first deion plate set or arc chute 470, a second deion plate set or arc chute 472, and a semiconductive gap assembly 450.

The deion plate sets 470, 472 each include a series of electrically conductive deion plates 473 separated by deion plate arc gaps 474.

The fuse elements 442, 444 may be constructed the same as the fuse elements 142, 144. The first fuse element 442 extends along the deion plate set 470 and electrically contacts an edge of each deion plate 473 thereof, and also electrically contacts the terminal 434 and a first gap electrode 443. The second fuse element 444 extends along the deion plate set 472 and electrically contacts an edge of each deion plate 473 thereof, and also electrically contacts the terminal 436 and a second gap electrode 445.

The semiconductive gap assembly 450 includes a semiconductive or trigger gap 452, the first gap electrode 443, the second gap electrode 445, and a semiconductive member 454 corresponding to the gap 152, the gap electrode 143, the gap electrode 145, and the semiconductive member 154, respectively. The gap electrodes 443, 445 are electrically conductive. The gap electrodes 443, 445 are mounted in the housing to be displaceable relative to one another.

The semiconductive member 454 is connected in electrical series between gap electrodes 443, 445, and thereby in electrical series between the fuse elements 342. In some embodiments and as illustrated, the opposed end faces of the semiconductive member 454 are each in electrical contact with a respective one of the gap electrodes 443, 445.

The disconnect mechanism 460 includes a movable separator (insulating) 462, a loading or biasing device (e.g., a spring) 463, and two meltable retainers or elements 464.

The movable separator 462 is electrically insulating. The spring 463 loads, biases or pushes the movable separator 462 in direction E2 to thereby drive the gap electrodes 443, 445 away from one another in opposing disconnect directions E3. The meltable elements 464 hold the gap electrodes 443, 445 in position against the load the spring 462.

The SGA fuse assembly 430 and the fused SPD assembly 400 may operate as follows in service.

During normal operation, the SPD OPC 110 practically acts as an insulator. The voltage applied across the semiconductive gap assembly 450 is insufficient to initiate a spark across the trigger gap 452. The SGA fuse assembly 430 remains in the configuration shown in FIG. 10 and no current is conducted through the SGA fuse element assembly 440.

When an overvoltage or current surge event (e.g., a transient power surge) applies a surge impulse current to the fused SPD circuit 401, the OPC 110 will temporarily go to a low impedance state (e.g., effectively becoming a short circuit), and the SGA fuse assembly 430 is supplied with an SPD surge impulse current as discussed above.

During the surge event, the voltage applied across the semiconductive gap assembly 450 by the surge event exceeds the prescribed threshold flashover voltage of the semiconductive gap assembly 450. In response, the voltage across the semiconductive gap assembly 450 initiates electrical arc flashover between the gap electrodes 443, 445 across the gap 452.

The semiconductive member 454 functions as a spark gap trigger, and initiation of the flashover is assisted by the semiconductive member 454, in the same manner as described above for the semiconductive member 154.

The surge current flows between the terminals 434, 436 through the fuse element 442, across the gap 452, and through the fuse element 444. When the supplied surge current ceases, the voltage across the gap electrodes 443, 445 drops below the ignition voltage, the flashover ends and the SGA fuse assembly 430 stops conducting. The fused SPD module 400 may return to its standby mode.

As discussed with regard to the SGA fuse element assembly 140, the SGA fuse element assembly 440 is capable of conducting this SPD surge impulse current without disintegrating or significantly degrading the SGA fuse element assembly 440 (i.e., without disintegrating or significantly degrading the fuse elements 442, 444 or the semiconductive member 454).

When a high short circuit event (condition 3) discussed above) occurs, the OPC 110 will supply the SGA fuse assembly 430 with a relatively high SPD short circuit current. The voltage applied across the gap 452 by the high short circuit event exceeds the prescribed threshold flashover voltage of the semiconductive gap assembly 450. In response, the voltage across the semiconductive gap assembly 450 initiates electrical arc flashover across the gap 452 between the gap electrodes 443 and 445. The semiconductive member 454 functions as a spark gap trigger that assists in initiating the flashover between the gap electrodes 443, 445 in the same manner as described above with regard to the semiconductive member 154. The high fault current initially flows between the terminals 434, 436 through the fuse element 442, across the gap 452, and through the fuse element 444.

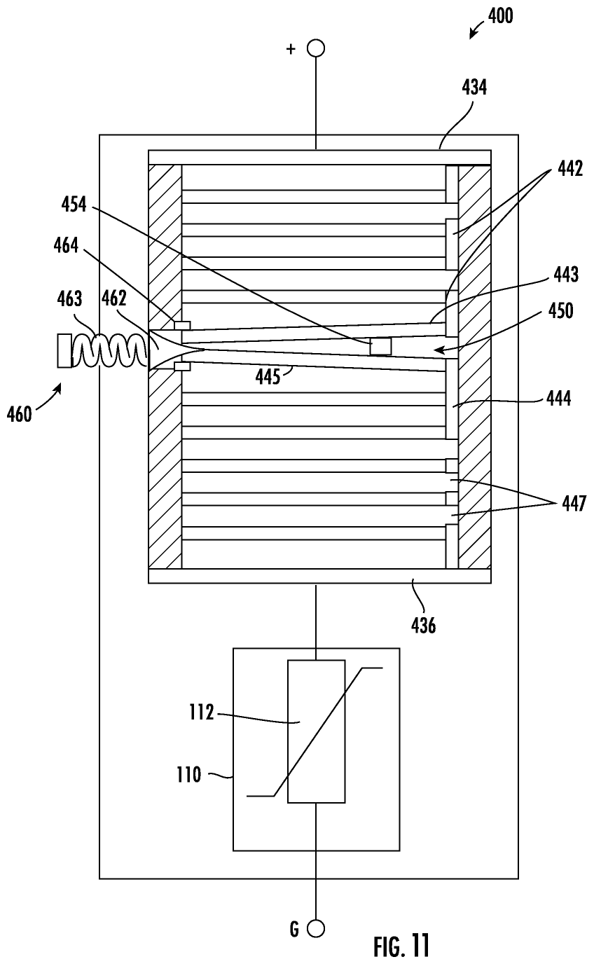

As illustrated in FIG. 11, the high fault current disintegrates connecting sections 447 of the fuse elements 442, 444 between the deion plates 473. As the high fault current disintegrates the connecting sections of the fuse elements, the current between the adjacent fuse element sections is redirected to arcing between the deion plates 473 at those locations. Each deion plate arc creates a voltage drop between the terminals. These voltage drops add together and increasingly reduce the voltage across the semiconductive gap assembly 450 to relatively low values, until the voltage across the semiconductive gap assembly 450 is less than the ignition voltage necessary to sustain the arcing between the gap electrodes 443, 445. The voltage across the semiconductive gap assembly 450 is then also less than necessary to trigger flashover between the gap electrodes 443, 445 or to conduct current through or along the surface of the semiconductive member 454. That is, at this lower voltage, the semiconductive member 454 operates as an electrical insulator between the gap electrodes 453, 445. The SGA fuse assembly 430 is thereby opened at the semiconductive gap assembly 450 and the fault current through the SGA fuse assembly 430 and the fused SDP module 400 is cut off or interrupted.

When a low short circuit event (condition 4) discussed above) occurs, the OPC 110 will supply the SGA fuse assembly 430 with a relatively low SPD short circuit current. The voltage applied across the semiconductive gap assembly 450 by the low short circuit event exceeds the prescribed threshold flashover voltage of the semiconductive gap assembly 450. In response, the voltage across the semiconductive gap assembly 450 initiates electrical arc flashover across the gap 452 between the gap electrodes 443 and 445.

During the low short circuit event, the semiconductive member 454 functions as a spark gap trigger that assists in initiating the flashover between the gap electrodes 443, 445 in the same manner as described above for the semiconductive member 154.

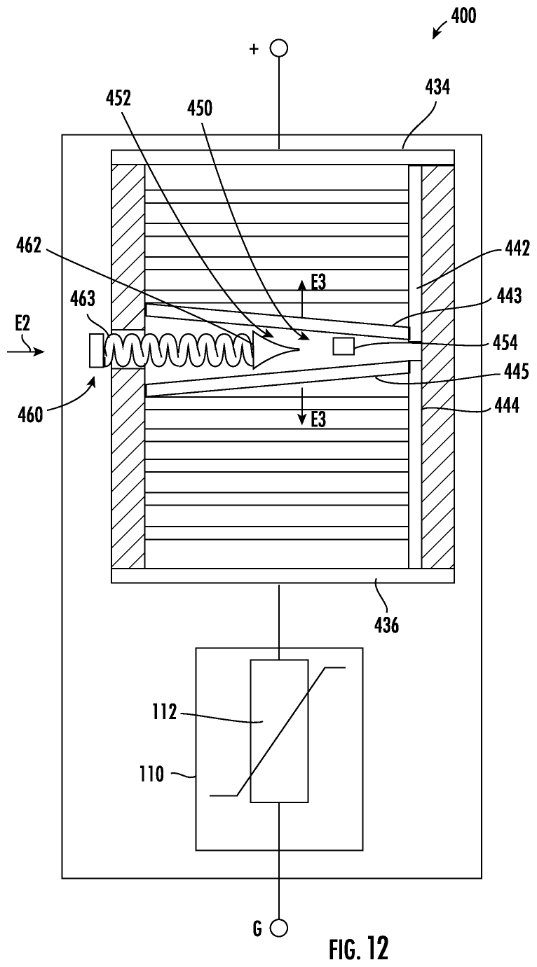

The low short circuit fault current then conducted through the SGA fuse element assembly 440 is insufficient to interrupt the current in the manner described above for a high short circuit fault current (i.e., by disintegrating the fuse element). Instead, the heat generated by the arcing across the semiconductive gap assembly 450 is conducted to one or both of the meltable elements 464, which causes the meltable elements 464 to melt (e.g., soften). As illustrated in FIG. 12, the melting of the meltable elements 464 permits the spring 463 to push the movable separator 462 in the direction E2, which forces the gap electrodes 443, 445 apart in directions E3. The gap electrodes 443, 445 are thereby spaced so far apart that the arcing between the gap electrodes 443, 445 can no longer be sustained. The fault current is thereby interrupted.

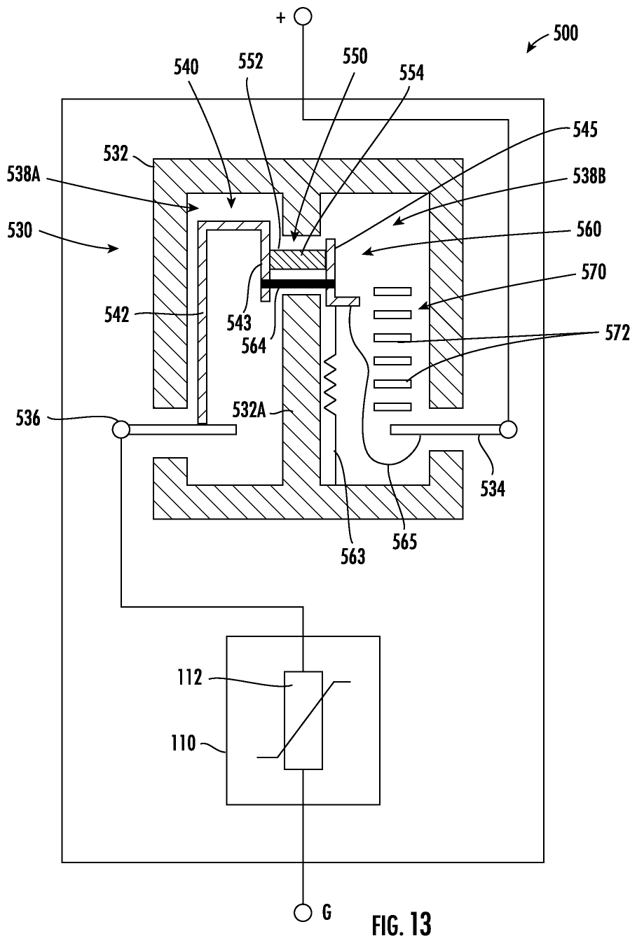

With reference to FIG. 13, a fused SPD module 500 according to further embodiments is shown therein. The fused SPD module 500 includes an SGA fuse assembly 530 and may be used and constructed in the same manner as the fused SPD module 300, except as follows.

The SGA fuse assembly 530 includes a module housing 532 and a partition wall 532A that define a fuse chamber 538A and a disconnect chamber 538B. The SGA fuse assembly 530 further includes terminal electrodes 534, 536, an SGA fuse element assembly 540, a thermally-actuated disconnect mechanism 560, a fusible flexible wire 565, and a set 570 of deion plates 572.

The SGA fuse element assembly 540 includes a fuse element 542 and a semiconductive gap assembly 550. The fuse element 542 may be constructed the same as the fuse element 142. The semiconductive gap assembly 550 includes a semiconductive or trigger gap 552, a first gap electrode 543, a second gap electrode 545, and a semiconductive member 554 corresponding to the gap 152, the gap electrode 143, the gap electrode 145, and the semiconductive member 154, respectively. The first gap electrode 543 is an end of the fuse element 542. The second gap electrode 545 is a movable contact forming a part of the disconnect mechanism 560.

The disconnect mechanism 560 includes the movable contact 545, a loading or biasing device (e.g., a spring) 563, a meltable retainer or element 564, and the flexible conductor 565. The meltable element 564 may be constructed and operate in the same manner as described for the meltable element 364.

The gap 552 is defined by and between the opposing gap electrodes 543 and 545. The semiconductive member 554 is positioned in the gap 552 and interposed between the gap electrodes 543 and 545. The semiconductive member 554 is connected in electrical series between the fuse elements 542 and the movable contact 545. In some embodiments and as illustrated, the opposed end faces of the semiconductive member 554 are each in electrical contact with a respective one of the gap electrodes 543, 545.

The movable contact 545 is electrically connected to the terminal 536 by the flexible conductor 565. The spring 563 loads, biases or pulls the movable contact 545 in a disconnect direction E4. The meltable element 564 holds the movable contact 545 in position relative to the gap electrode 543 against the load the spring 563.

The SGA fuse assembly 530 is configured to operate in the same manner as the SGA fuse assembly 330 in response to surge current events.

The SGA fuse assembly 530 is configured to operate in the same manner as the SGA fuse assembly 330 in response to a low short circuit event (condition 4) discussed above). When a low short circuit event (condition 4) discussed above) occurs, the OPC 110 will supply the SGA fuse assembly 530 with a relatively low SPD short circuit current. During the low short circuit event, the voltage applied across the semiconductive gap assembly 550 by the low short circuit event exceeds the prescribed threshold flashover voltage of the semiconductive gap assembly 550. In response, the voltage across the semiconductive gap assembly 550 initiates electrical arc flashover across the gap 552.

The low short circuit fault current then conducted through the SGA fuse element assembly 540 is insufficient to interrupt the current by disintegrating the fuse element 542 or the fusible wire 565. Instead, the heat generated by the arcing across the semiconductive gap assembly 550 is conducted to the meltable element 564, which causes the meltable element 564 to melt (e.g., soften). The melting of the meltable element 564 permits the spring 563 to displace or pull the gap electrode (movable contact) 545 away from the gap electrode 543, thereby disconnecting the terminal 536 of the SGA fuse device 530 from the fuse element 542. The fault current is thereby interrupted.

The SGA fuse assembly 530 differs from the SGA fuse assembly 330 in its response to a high short circuit (fault) current.

When a high short circuit event (condition 3) discussed above) occurs, the OPC 110 will supply the SGA fuse assembly 530 with a relatively high SPD short circuit current. The voltage applied across the gap 552 by the high short circuit event exceeds the prescribed threshold flashover voltage of the semiconductive gap assembly 550. In response, the voltage across the semiconductive gap assembly 550 initiates electrical arc flashover across the gap 552 between the gap electrodes 543 and 545. The semiconductive member 554 functions as a spark gap trigger that assists in initiating the flashover between the gap electrodes 543, 545 in the same manner as described above with regard to the semiconductive member 154. The high fault current initially flows between the terminals 534, 536 through the fuse element 542, across the gap 552, and through the flexible fusible wire 565.

The high fault current disintegrates the fuse element 542 and the fusible flexible wire 565. As the high fault current disintegrates the flexible fusible wire 565, the current is redirected to (flashes over to or arcs to) the deion plates 573 from the electrode 545 and/or the flexible fusible wire 565. The current then flows through the set 570 of deion plates to the terminal 534 by arcing between the deion plates 573. Each deion plate arc creates a voltage drop between the terminals. These voltage drops add together and increasingly reduce the voltage across the semiconductive gap assembly 550 to relatively low values, until the voltage across the semiconductive gap assembly 550 is less than the ignition voltage necessary to sustain the arcing between the gap electrodes 543, 545. The voltage across the semiconductive gap assembly 550 is then also less than necessary to trigger flashover between the gap electrodes 543, 545 or to conduct current through or along the surface of the semiconductive member 554. That is, at this lower voltage, the semiconductive member 554 operates as an electrical insulator between the gap electrodes 543, 545. The SGA fuse assembly 530 is thereby opened at the semiconductive gap assembly 550 and the fault current through the SGA fuse assembly 530 and the fused SDP module 500 is cut off or interrupted.

In some embodiments, the fuse element or fuse elements as disclosed herein are bimetallic fuse elements. For the purpose of explanation, the construction and operation of a bimetallic fuse element 142 (i.e., of the fuse assembly 130) will be described. However, any or each of the fuse elements described herein (e.g., the fuse elements 144, 242, 342, 442, 444, or 542) may also be a bimetallic fuse element as described and may function in the same manner.

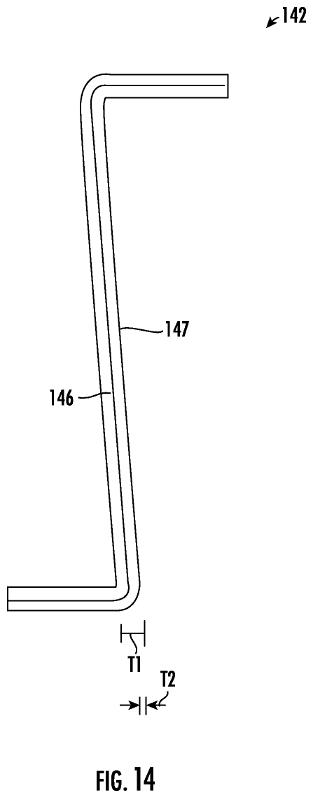

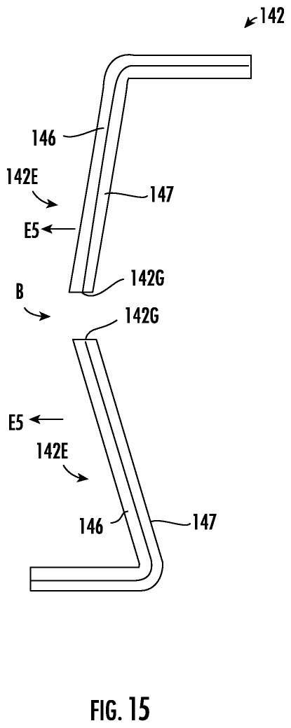

With reference to FIGS. 14 and 15, the bimetallic fuse element 142 is a bimetallic strip including a first or inner metal band or layer 146 and a second or outer metal band or layer 147 mated (e.g., face to face) with the inner metal layer 146 along the length of the fuse element 142. The inner metal layer 146 and the outer metal layer 147 are formed of different metal compositions from one another. More particularly, the outer metal layer 147 is formed of a metal having a higher coefficient of thermal expansion than that of the inner metal layer 146. When the fuse element 142 is heated, the different rates of thermal expansion between the metal layers 146, 147 will cause the fuse element 142 to bend or deform in a deformation direction E5.

In some embodiments, the bimetallic fuse element 142 further includes a third metal band or layer (not shown) mated (e.g., face to face) with the inner metal layer 146 or the outer metal layer 147 along the length of the fuse element 142. In some embodiments, the third metal layer is formed of a metal having a higher electrical conductivity than the metals or alloys forming the inner metal layer 146 and the outer metal band or layer 147.

The metal layers 146, 147 may be formed of any suitable metals. In some embodiments, the inner metal layer 146 (i.e., the low expansion side layer) is formed of FeNi36 nickel alloy, and the outer metal layer 147 (i.e., the high expansion side layer) is formed of FeNi22Cr3 nickel alloy.

In some embodiments, the fuse element 142 has a specific thermal curvature in the range of 1×10⁻⁶ to 30×10⁻⁶ [K⁻¹] and a specific resistance in the range of 1×10⁻⁸ to 1×10⁻⁶ [Ωm].

In some embodiments, the fuse element 142 has a strip thickness T1 in the range of from about 0.5 mm to 2 mm.

In some embodiments, the inner metal layer 146 and the outer metal layer 147 each have a layer thickness T2 in the range of from about ⅓ to ⅔ times the overall thickness T1 of the fuse element 142.

When the fuse assembly 130 is subjected to a high short circuit event, the high fault current will heat, melt and disintegrate the fuse element 142 as described above with reference to FIGS. 1-5. As discussed above, the fuse element 142 will disintegrate or break apart at a midsection of the fuse element 142 to form a gap or break B as shown in FIG. 15, for example. Once the fuse element 142 has broken, electrical arcing will occur between the opposed ends 142G of the fuse element 142 at the break B. This arcing causes a portion or portions of the fuse element 142 at these opposed ends 142G to quickly evaporate or disintegrate. The extinguishing agent 139, the loss of material from the fuse element 142, and/or the spatial distance between the opposed ends 142G at the break B will then cause the electrical arcing to terminate, cease or be extinguished.

Additionally, the bimetallic fuse element 142 will bend or deform in directions E5 in response to the heat generated in the bimetallic fuse element 142. More particularly, in response to the heat generated in the remaining sections 142E of the bimetallic fuse element 142 by the surge current flowing therethrough, the layers 146 and 147 are differentially expanded as discussed above. The differentially expanding layers 146 and 147 cause the sections 142E to bend, deform or deflect in directions E5. This bending or deformation can assist in spacing apart the opposed ends 142G at the break B to extinguish arcing. However, in some situations, the electrodes 134, 136 may be fully disconnected by the disintegration of the fuse elements 142, 144 before the sections 142E bend or deform, or before the extent of the bending or deformation can appreciably contribute to the disconnection.

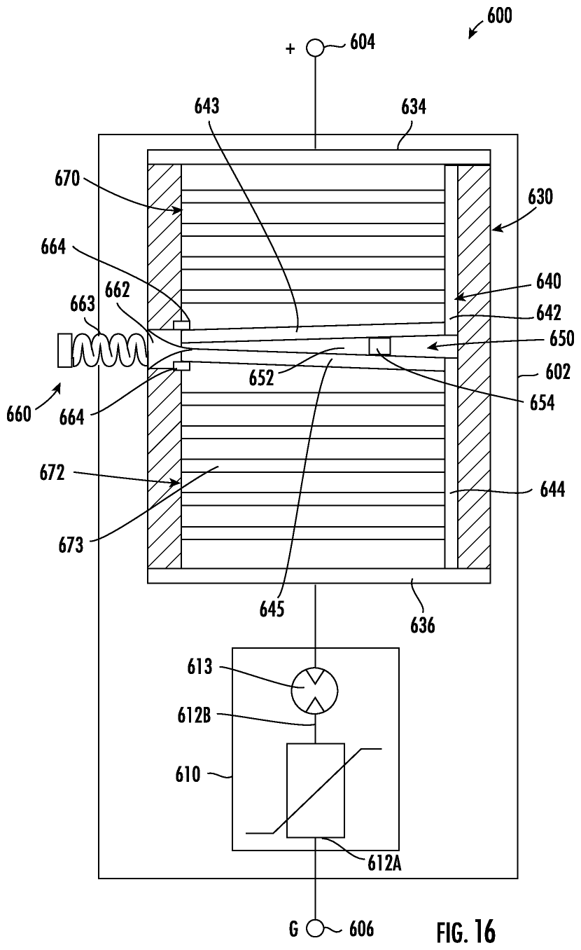

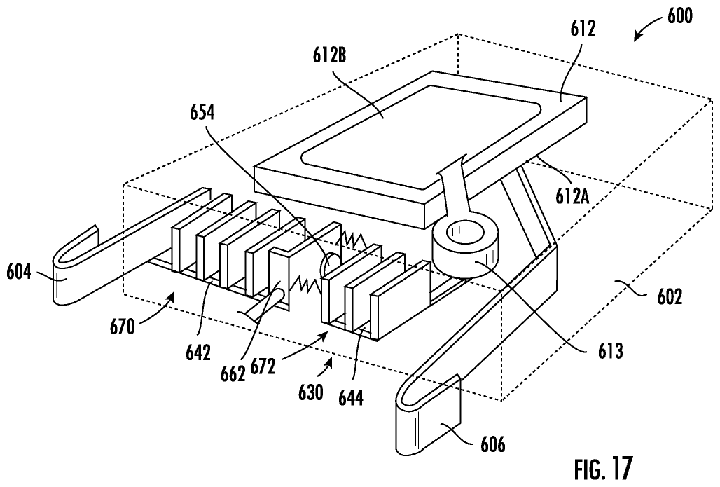

With reference to FIGS. 16 and 17, a fused SPD module 600 according to further embodiments is shown therein. The fused SPD module 600 includes an SGA fuse assembly 630 and may be used and constructed in the same manner as the fused SPD module 400, except as follows.

The fused SPD module 600 includes the SGA fuse assembly 630, a module carrier or housing 602, and module electrical terminals 604, 606 corresponding to the SGA fuse assembly 430, the module housing 102, and the module electrical terminals 104, 106.

The SGA fuse assembly 630 includes a first terminal electrode 634, a second terminal electrode 636, a chamber 638, an SGA fuse element assembly 640, a thermally-actuated disconnect mechanism 660, a first fuse element 642, a second fuse element 644, a first deion plate set 670 (including electrically conductive deion plates 673), a second deion plate set 672, a semiconductive gap assembly 650, a semiconductive or trigger gap 652, a first gap electrode 643, a second gap electrode 645, a semiconductive member 454, a movable separator (insulating) 662, a loading or biasing device (e.g., a spring) 663, and two meltable retainers or elements 664 corresponding to the first terminal electrode 434, the second terminal electrode 436, the chamber 438, the SGA fuse element assembly 440, the thermally-actuated disconnect mechanism 460, the first fuse element 442, the second fuse element 444, the first deion plate set 470, the second deion plate set 472, the semiconductive gap assembly 450, the gap 452, the first gap electrode 443, the second gap electrode 445, the semiconductive member 454, the movable separator 462, the loading device 463, and meltable elements 464, respectively. The housing 602 is shown in dashed lines in FIG. 17 for clarity.

The fused SPD module 600 further includes an OPC 610 corresponding to the OPC 110 of the fused SPD module 400, except that the OPC 610 includes both a varistor (e.g., MOV) 612 and a GDT 613. The varistor 610 and the GDT 613 are provided in electrical series with one another and with the fuse assembly 630. A first electrode 612A electrically connects the varistor 612 to the terminal 606 and a second electrode 612B electrically connects an opposing side of the varistor 612 to the fuse assembly 630.

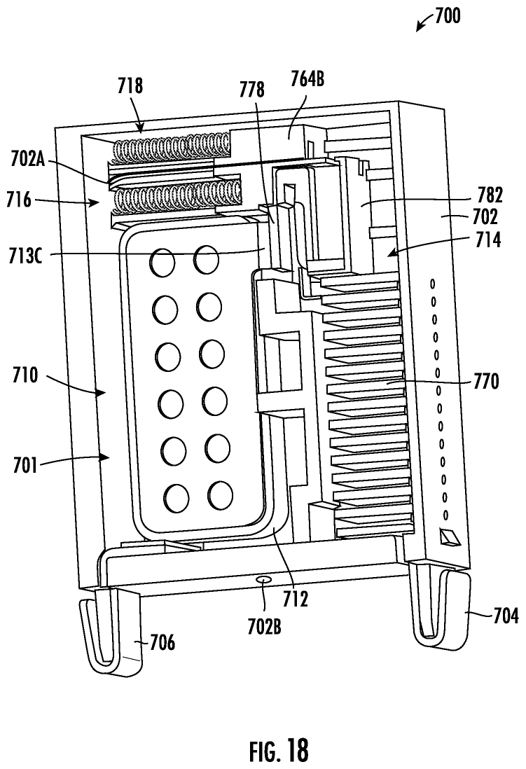

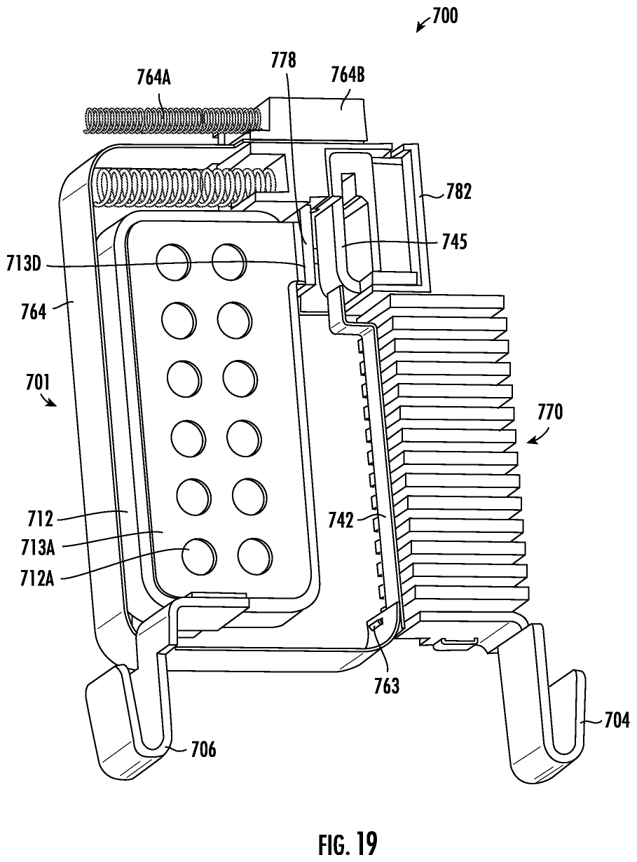

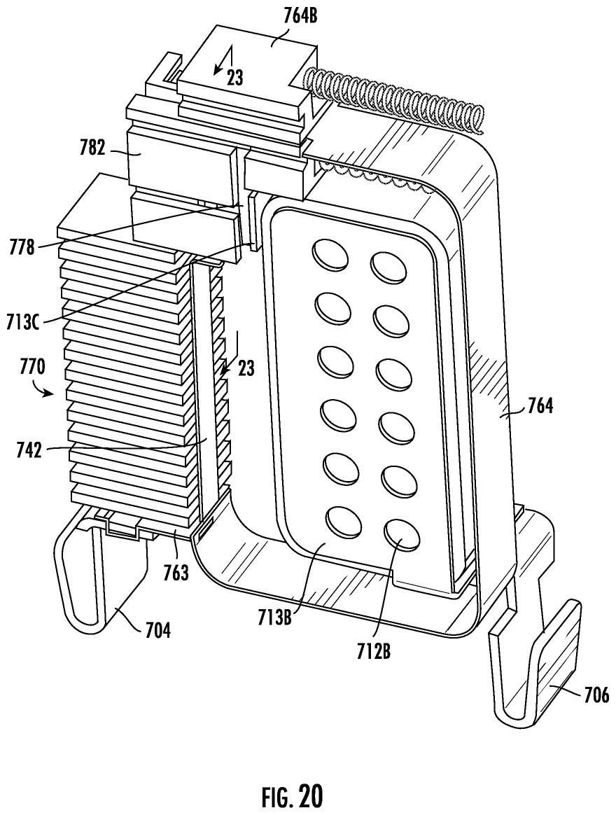

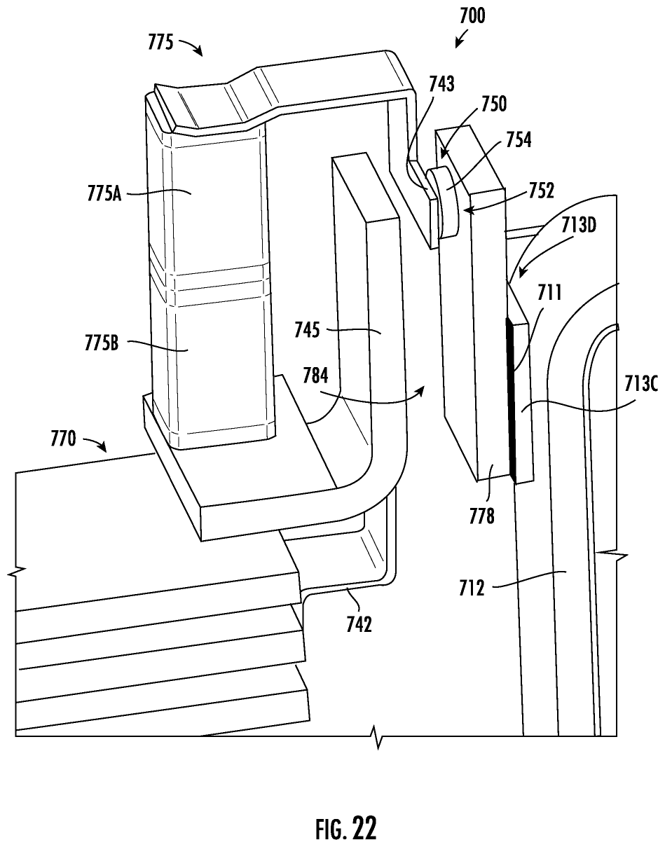

With reference to FIGS. 18-27, a fused SPD module 700 according to further embodiments is shown therein. The fused SPD module 700 includes a module housing 702, a first electrical contact or terminal 704, a second electrical contact or terminal 706, an overvoltage protection circuit (OPC) 710, an integrated overcurrent protection circuit 714, a thermal disconnect indicator mechanism 716, and an overcurrent indicator mechanism 718. The overcurrent protection circuit 714 and the OPC 710 are disposed in the housing 702, and are electrically connected between the terminals 704 and 706 to form a fused SPD electrical circuit 701.

In some embodiments, the fused SPD module 700 is provided, installed and used as a component in a protection circuit of a power supply circuit 10 in place of the SPD module 100 as shown in FIG. 1, for example. In the power supply circuit 10, the OPC 710 is in electrical series with the integrated overcurrent protection circuit 714, and the OPC 710 and the overcurrent protection circuit 714 are in electrical parallel across sensitive equipment. The fused SPD module 700 is designed to protect the sensitive equipment from overvoltages and current surges. The fused SPD module 700 may also be connected to the power source via an upstream second fuse or circuit breaker 12.

The overcurrent protection circuit 714 and the OPC 710 are disposed in the housing 702, and are electrically connected between the terminals 704 and 706 to form a fused SPD electrical circuit 701. The housing 702 may be formed of any suitable electrically insulating material. In some embodiments, the housing 132 is formed of a polymeric material (e.g., a plastic), which may include glass fibers, or any other suitable electrically insulating material. The housing 702 may include an outer cover corresponding to the cover 802C discussed below.

The OPC 710 includes a varistor 712. In some embodiments, the varistor 712 is an MOV. The varistor 712 has a first side 712A and an opposing second side 712B. A first electrically conductive varistor electrode 713A electrically connects the first side 712A to the terminal 706. A second electrically conductive varistor electrode 713B contacts the second side 712B and includes a joint tab 713C.

The integrated overcurrent protection circuit 714 includes a thermal disconnect mechanism 760, a spark gap assembly 780, a fuse assembly 730, a triggering circuit 775 (including a triggering (semiconductive) spark gap assembly 750), and a main spark gap 784.

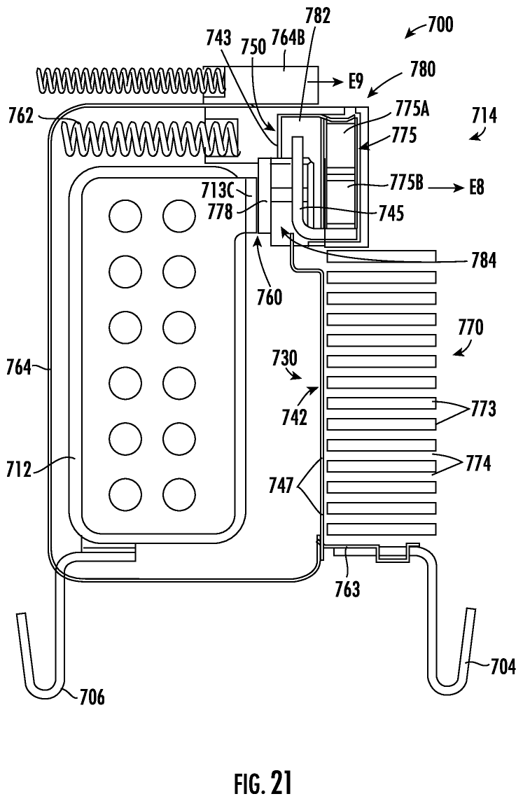

With reference to FIG. 21, the spark gap assembly 780 includes a spark gap carrier 782, a triggering electrode (first gap electrode) 743, a thermal disconnect joint electrode (second gap electrode) 778, and a movable deion plate (third gap electrode) 745.

The electrodes 778, 743 are formed of a suitable electrically conductive metal.

The spark gap carrier 782 may be formed of an electrically nonconductive polymer, for example.

The triggering circuit 775 includes a varistor 775A connected in electrical series with a GDT 775B, and the triggering (semiconductive) spark gap assembly 750. The triggering spark gap assembly 750 includes a triggering electrode (first gap electrode) 743, a thermal disconnect joint electrode (second gap electrode) 778, and a semiconductive or trigger gap 752 defined between the electrodes 743 and 778. The triggering spark gap assembly 750 further includes a semiconductive member 754, corresponding to and constructed as described herein for the semiconductive member 154. The semiconductive member 754 spans the distance between and engages each of the electrodes 743 and 778.

The main spark gap 784 is defined by and between the movable deion plate (third gap electrode) 745 and the thermal disconnect joint electrode 778.

The fuse assembly 730 includes a deion plate set 770 and a fuse element 742. The deion plate set 770 may be constructed and operate in the same manner as described for the deion plate set 470. The deion plate set 770 includes a series of deion plates 773 that define a series of spark gaps 774 therebetween. The fuse element 742 may be constructed and operate in the same manner as described for the fuse element 142.

The varistor 712, the varistor electrodes 713A, 713B (including the tab 713C), and the deion plates 773 are mounted to remain stationary in or relative to the housing 702. A portion of the fuse element 742 extends along the edges of the deion plates 773 (e.g., in contact with or closely adjacent the deion plates 773) as illustrated in FIG. 21, for example. The fuse element 742 is electrically connected at one end to the movable deion plate 745 at one end and to the terminal 704 at its opposing end.

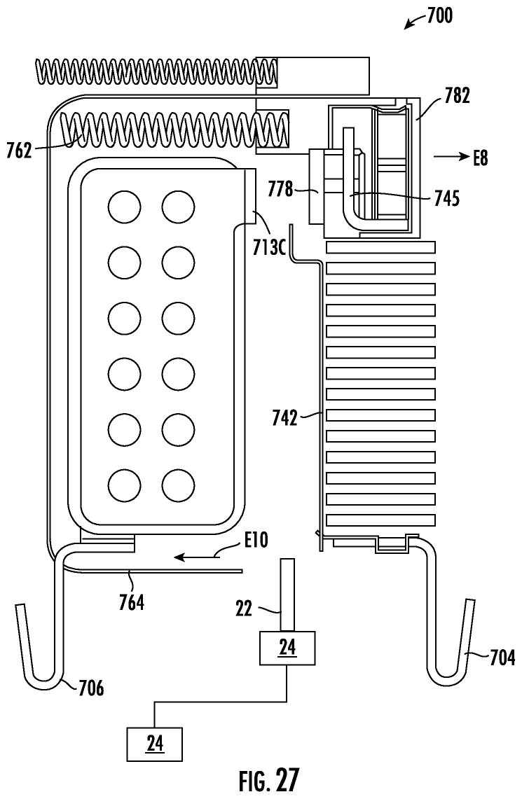

The spark gap carrier 782 is movably or slidably mounted in the housing 702 to move in a release direction E8 from a ready position (as shown in FIG. 21) to an open position (as shown in FIG. 27). The spark gap carrier 782 is biased, loaded, or urged in the direction E8 by a spark gap carrier spring 762. The disconnect joint electrode 778, the triggering electrode 743, the movable deion plate 745, the varistor 775A, the GDT 775B, the main spark gap 784, and the triggering spark gap assembly 750 (including the semiconductive member 754) are mounted on the spark gap carrier 782 for movement therewith. The varistor 775A, and the GDT 775B are arranged in electrical series between the triggering electrode 743 and the movable deion plate 745.

The thermal disconnect mechanism 760 includes the thermal disconnect joint electrode 778, the joint tab 713C, and a solder 711. The solder 711 bonds the thermal disconnect joint electrode 778 to the joint tab 713C to form a releasable joint 713D. As discussed below, the solder 711 can be heated by heat generated by the varistor 712 and/or the main spark gap 784, thereby causing the solder 711 to melt or soften and release the thermal disconnect joint electrode 778 from the joint tab 713C.

The thermal disconnect indicator mechanism 716 includes the spark gap carrier 782, the spring 762, a retention spring 763, an indicator element or strip 764, a guide slot 702A (defined in the housing 702), and a remote switch hole 702B (defined in the housing 702).

The overcurrent indicator mechanism 718 includes an indicator member 764B, a spring 764A, the retention spring 763, the indicator strip 764, and the hole 702B. The spring 764A urges the indicator member 764B in a direction E9.

The retention spring 763 is affixed to the terminal 706. The retention spring 763 is disintegrable or meltable. The strip 764 is slidably seated in the guide slot 702A. One end of the strip 764 is affixed to the retention spring 763. The opposing end of the strip 764 is coupled to each of the spark gap carrier 782 and the indicator member 764B. The spark gap carrier 782 and the indicator member 764B are movable independently of one another such that either member 782, 764B can pull the indicator strip 764 while the other member 782, 764A remains stationary. The indicator strip 764 may be formed of a flexible, electrically nonconductive material.

According to some embodiments of the inventive concept, the fused SPD module 700 is configured to operate under the four different conditions discussed above with regard to the fused SPD module 100 (i.e., 1) normal (stand by) operation; 2) an overvoltage or current surge event in which the fused SPD module 700 is designed to shunt an SPD surge impulse current to ground; 3) a high short circuit (fault) event; and 4) a low short circuit (fault) event).

During normal operation, the varistor 712 practically acts as an insulator. The voltage applied across the triggering spark gap assembly 750 is insufficient to initiate a spark across the trigger spark gap 752. The fused SPD module 700 remains in the configuration shown in FIG. 21 and no current is conducted through the fuse element 742.

When an overvoltage or current surge event (e.g., a transient power surge) applies a surge impulse current to the fused SPD circuit 701, the varistor 712 will temporarily go to a low impedance state (e.g., effectively becoming a short circuit), and the integrated overcurrent protection circuit 714 is supplied with an SPD surge impulse current. The varistor 712 is designed to shunt the surge impulse current associated with such events to ground to protect sensitive equipment. The SPD surge impulse current may be on the order of tens of kA, but will typically last only a short duration (in the range of from about tens of microseconds to a few milliseconds).

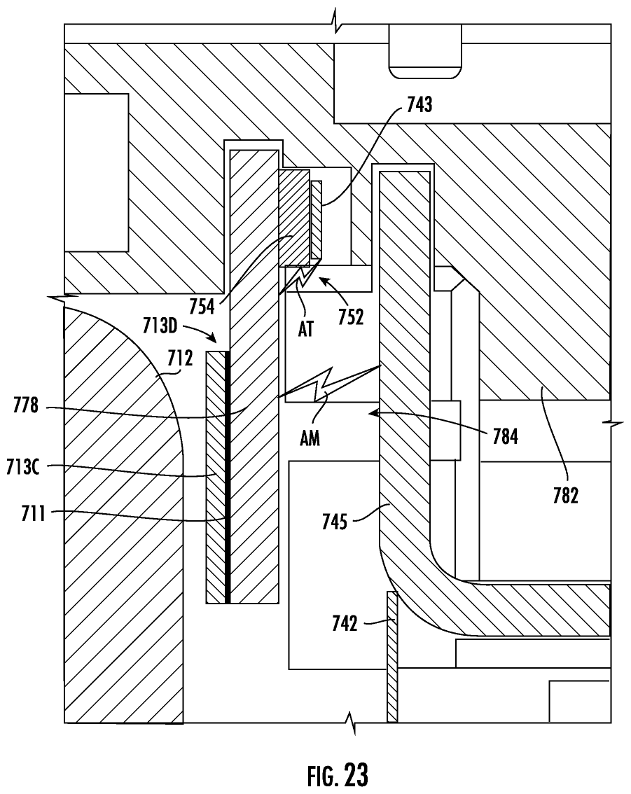

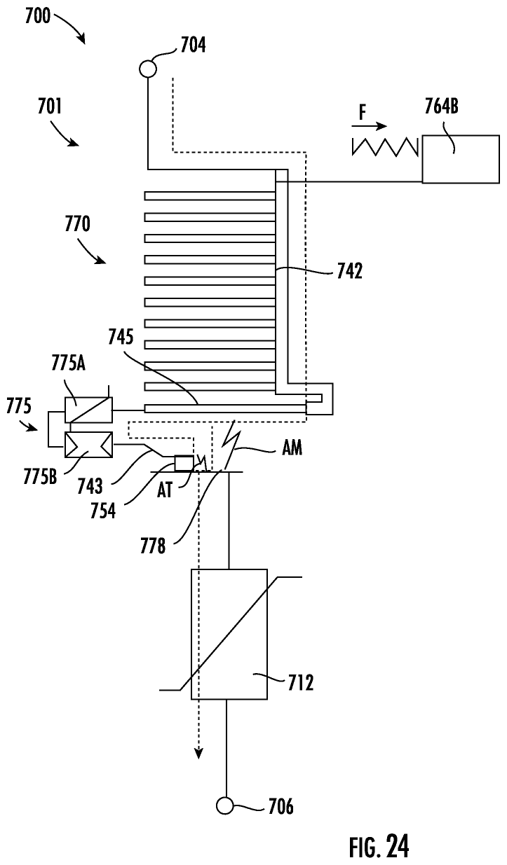

During the surge event, the current initially flows through the fuse element 742, the movable deion plate 745, the varistor 775A, the GDT 775B, and the triggering electrode 743, across the triggering spark gap assembly 750, and through the thermal disconnect joint electrode 778, the electrode 713B, the varistor 712, and the electrode 713A to the terminal 706, as illustrated in FIG. 24. The voltage applied across the trigger gap 752 by the surge event exceeds the prescribed threshold flashover voltage of the triggering spark gap assembly 750. In response, the voltage across the triggering spark gap assembly 750 initiates electrical arc flashover AT (FIGS. 23 and 24) across the trigger gap 752. That is, electrical arcing AT is generated between the gap electrodes 743 and 778. The initiation of the electrical arc flashover AT is assisted by the semiconductive member 754 in response to the overvoltage developed across the electrodes 743, 778 in the same manner as described above for the semiconductive gap assembly 150 and the semiconductive member 154.

Shortly after the start of the electrical arc flashover AT (e.g., within microseconds), the current flow triggers an electric arc flashover AM (FIGS. 23 and 24) across the main spark gap 784 between the electrodes 745 and 778. The full surge current is thereby diverted from the triggering circuit 775 to the main spark gap 784.

When the supplied surge current ceases, the voltage across the gap electrodes 743 and 778 and between the electrodes 745 and 778 drops below the ignition voltage, the flashover ends and the overcurrent protection circuit 714 stops conducting. The fused SPD module 700 may return to its standby mode. The fused SPD module 700 remains in its ready configuration and the indicator mechanisms 716, 718 are not triggered.

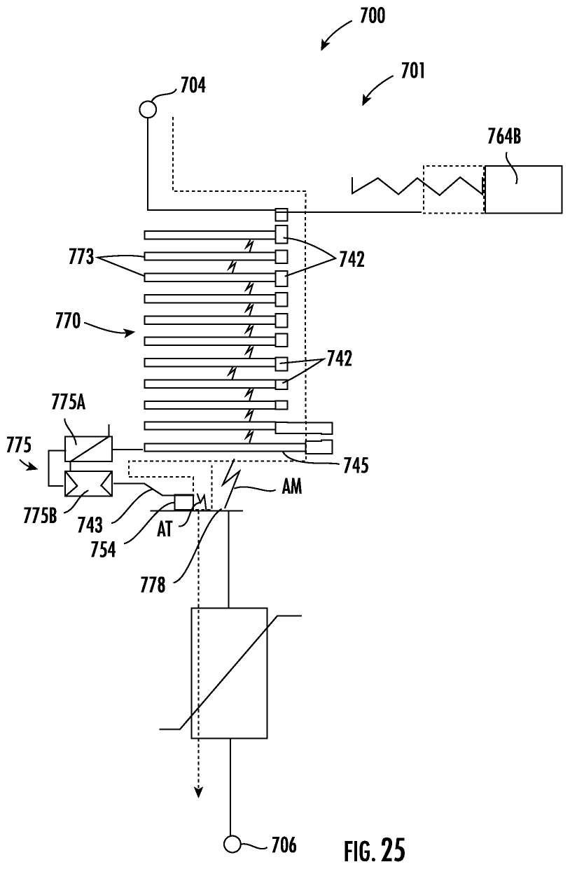

When a high short circuit event (condition 3) discussed above) occurs, the varistor 712 will supply the overcurrent protection circuit 714 with a relatively high SPD short circuit current. During the high short circuit event, the current initially flows through the fuse element 742, the movable deion plate 745, the varistor 775A, the GDT 775B, and the triggering electrode 743, across the triggering spark gap assembly 750, and through the thermal disconnect joint electrode 778, the electrode 713B, the varistor 712, and the electrode 713A to the terminal 706, as illustrated in FIG. 25. The voltage applied across the trigger gap 752 by the surge event exceeds the prescribed threshold flashover voltage of the triggering spark gap assembly 750. In response, the voltage across the triggering spark gap assembly 750 initiates electrical arc flashover AT (FIGS. 23 and 25) across the trigger gap 752. That is, electrical arcing AT is generated between the gap electrodes 743 and 778. The initiation of the electrical arc flashover AT is assisted by the semiconductive member 754 in response to the overvoltage developed across the electrodes 743, 778 in the same manner as described above for the semiconductive gap assembly 150 and the semiconductive member 154.

Shortly after the start of the electrical arc flashover AT (e.g., within microseconds), the current flow triggers an electric arc flashover AM (FIGS. 23 and 25) across the main spark gap 784 between the electrodes 745 and 778. The full surge current is thereby diverted from the triggering circuit 775 to the main spark gap 784.

As illustrated in FIG. 25, the high fault current disintegrates connecting sections 747 of the fuse element 742 between the deion plates 773. As the high fault current disintegrates the connecting sections of the fuse elements, the current between the adjacent fuse element sections is redirected to arcing between the deion plates 773 at those locations. Each deion plate arc creates a voltage drop between the terminals. These voltage drops add together and increasingly reduce the voltage across the triggering spark gap assembly 750 and the main spark gap 784 to relatively low values, until the voltage across the triggering spark gap assembly 750 and the main spark gap 784 is less than the ignition voltage necessary to sustain the arcing between the gap electrodes 743 and 778 and between the electrodes 745 and 778. The voltage across the triggering spark gap assembly 750 is then also less than necessary to trigger flashover between the gap electrodes 743, 778 or to conduct current through or along the surface of the semiconductive member 754. That is, at this lower voltage, the semiconductive member 474 operates as an electrical insulator between the gap electrodes 743, 778. The overcurrent protection circuit 714 is thereby opened at the triggering spark gap assembly 750 and the main spark gap 784, and the fault current through the overcurrent protection circuit 714 and the fused SDP module 700 is cut off or interrupted. The thermal disconnect joint 713D remains intact.

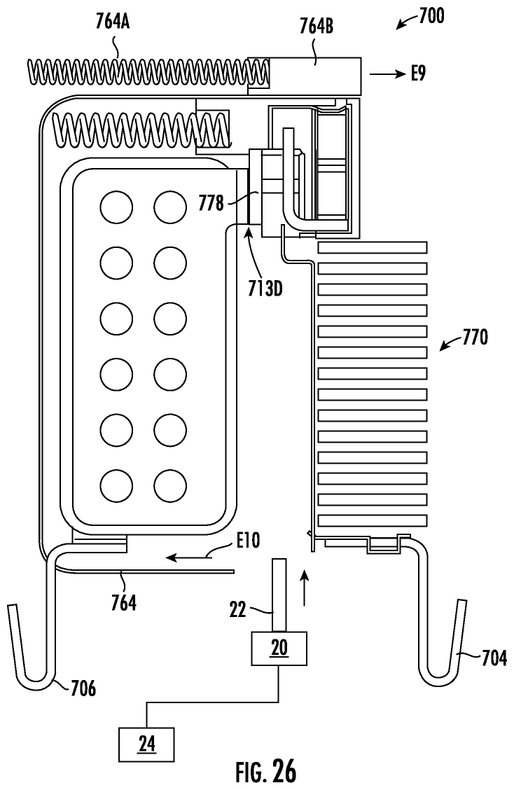

The high fault current also actuates the overcurrent indicator mechanism 718. During the high fault current, the disintegration of the fuse element 742 will cause melting of the retention spring 763. The melting of the retention spring 763 enables the spring 764A to pull the indicator member 764B and the indicator strip 764 in a direction E10, as illustrated in FIG. 26. This displacement of the indicator strip 764 enables a pin 22 of a remote sensor switch 20 to move into the housing 702 through the hole 702B. The change of state of the switch 20 is transmitted to a remote monitoring system 24 to indicate that the SPD module 700 has failed. The displacement of the indicator member 764B can also serve as a local alert or indicator. For example, the indicator member 764B may be visible through an opening in the housing.

When a low short circuit event (condition 4) discussed above) occurs, the varistor 712 will supply the overcurrent protection circuit 714 with a relatively low SPD short circuit current. During the low short circuit event, the current initially flows through the fuse element 742, the movable deion plate 745, the varistor 775A, the GDT 775B, and the triggering electrode 743, across the triggering spark gap assembly 750, and through the thermal disconnect joint electrode 778, the electrode 713B, the varistor 712, and the electrode 713A to the terminal 706 (i.e., the same current path as illustrated in FIG. 23). The voltage applied across the trigger gap 752 by the surge event exceeds the prescribed threshold flashover voltage of the triggering spark gap assembly 750. In response, the voltage across the triggering spark gap assembly 750 initiates electrical arc flashover AT (FIG. 23) across the trigger gap 752. That is, electrical arcing AT is generated between the gap electrodes 743 and 778. The initiation of the electrical arc flashover AT is assisted by the semiconductive member 754 in response to the overvoltage developed across the electrodes 743, 778 in the same manner as described above for the semiconductive gap assembly 150 and the semiconductive member 154.

Shortly after the start of the electrical arc flashover AT (e.g., within microseconds), the current flow triggers an electric arc flashover AM (FIG. 23) across the main spark gap 784 between the electrodes 745 and 778. The full surge current is thereby diverted from the triggering circuit 775 to the main spark gap 784.

The low short circuit fault current then conducted through overcurrent protection circuit 714 is insufficient to interrupt the current in the manner described above for a high short circuit fault current (i.e., by disintegrating the fuse element 742). Instead, the heat generated by the varistor 712 is conducted to the solder 711 via the tab 713C, which causes the solder 711 to melt (e.g., soften). Additionally, the heat generated in the electric arc AM is also conducted to the solder 711 via the electrode 778 to contribute to the softening of the solder 711. As illustrated in FIG. 27, the melting of the solder 711 permits the spark gap carrier spring 762 to force the spark gap carrier 782, and thereby the electrode 778, in the direction E8 away from the tab 713C. The electrode 778 and the tab 713C are thereby spaced so far apart that the electrical circuit is opened therebetween. The fault current is thereby interrupted. The combination of the heating by the varistor 712 and the heating by the main spark gap 784 can increase the reliability and rate of response of the thermal disconnect mechanism 760.

The low short circuit fault current also actuates the overcurrent indicator mechanism 718. During the low fault current, the retention spring 763 is not melted. Instead, the release of the spark gap carrier 782 at the joint 713D enables the spark gap carrier spring 762 to pull the spark gap carrier 782 and the indicator strip 764 in the direction E10 (FIG. 27). This displacement of the indicator strip 764 enables the pin 22 of the remote sensor switch 20 to move into the housing 702 through the hole 702B. The change of state of the switch 20 is transmitted to a remote monitoring system 24 to indicate that the SPD module 700 has failed. The displacement of the spark gap carrier 782 can also serve as a local alert or indicator. For example, the spark gap carrier 782 may be visible through an opening in the housing.

The spark gap carrier 782 and the indicator member 764B are movable independently of one another. According to some embodiments, the spring force of the spring 764A is less than the spring force of the retention spring 763, which is less than the spring force of the spark gap carrier spring 762. Once the thermal disconnect mechanism 760 operates, the spark gap carrier spring 762 must pull the strip 764 by bending the retention spring 763, while the spring 764A should not be able to bend the retention spring 763 otherwise a false indication would be executed. However, when the fused SPD module 700 responds to and interrupts a high fault current, the spring 764A must be able to displace the strip 764 and the indicator member 764B.

The varistor 775A and the GDT 775B are connected in electrical series with the semiconductive member 754 and in electrical parallel with the main spark gap 784. The varistor 775A and the GDT 775B serve to cut off any continuation currents along or through the semiconductive member 754 after the main spark gap arc AM is initiated.

The fused SPD module 700 can provide several benefits. The SPD module 700 can withstand surge and lightning events, is current leakage free (as there is a gap in series that prevents current conduction through the varistor 712 in the event of an overvoltage or MOV derating), and can also interrupt currents from a very low level compared to standard circuit breakers and fuses (e.g., from 50 A or lower while standard fuses can disconnect from about 1.4 times the load current, which is around 300 A as a minimum).

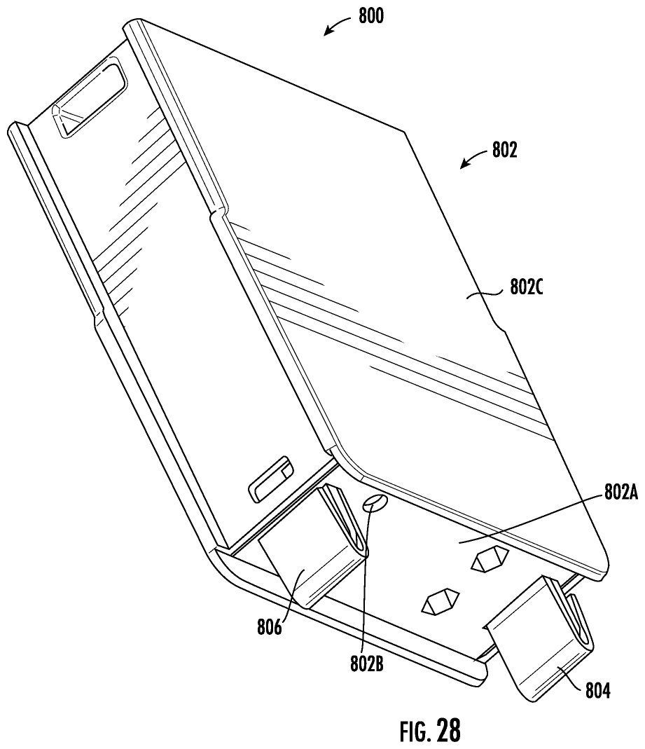

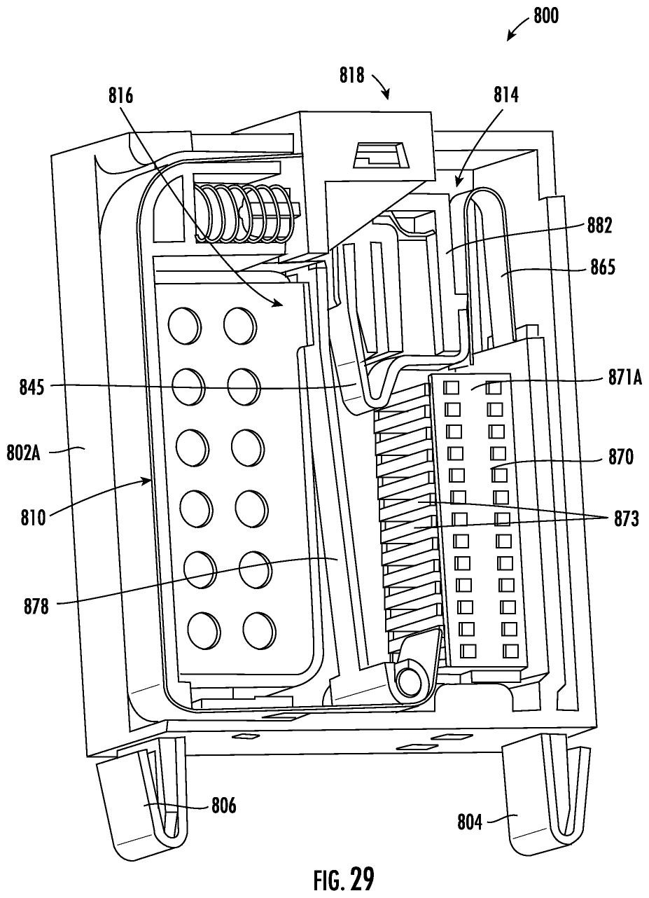

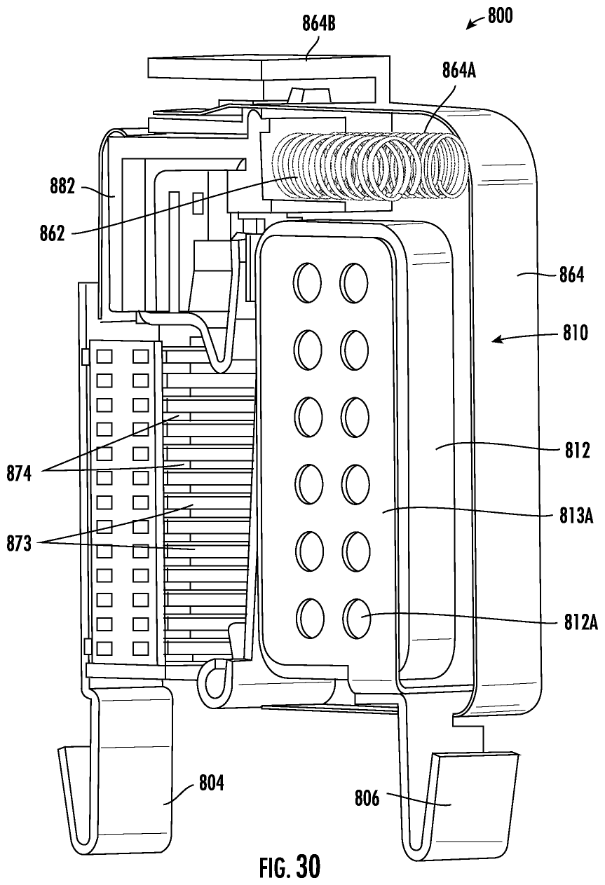

With reference to FIGS. 28-34, an SPD module 800 according to further embodiments is shown therein. The SPD module 800 includes a module housing 802, a first electrical contact or terminal 804, a second electrical contact or terminal 806, an overvoltage protection circuit (OPC) 810, an integrated overcurrent protection circuit 814, a thermal disconnect indicator mechanism 816, and an overcurrent indicator mechanism 818. The overcurrent protection circuit 814 and the OPC 810 are disposed in the housing 802, and are electrically connected between the terminals 804 and 806 to form an SPD electrical circuit 801.

In some embodiments, the SPD module 800 is provided, installed and used as a component in a protection circuit of a power supply circuit 10 in place of the SPD module 100 as shown in FIG. 1, for example. In the power supply circuit 10, the OPC 810 is in electrical series with the integrated overcurrent protection circuit 814, and the OPC 810 and the overcurrent protection circuit 814 are in electrical parallel across sensitive equipment. The SPD module 800 is designed to protect the sensitive equipment from overvoltages and current surges. The SPD module 800 may also be connected to the power source via an upstream fuse or circuit breaker 12.

The housing 802 may be formed of the same material as described for the housing 702. The housing 802 includes an inner housing member or frame 802A and an outer cover 802C.

The OPC 810 includes a varistor 812. In some embodiments, the varistor 812 is an MOV. The varistor 812 has a first side 812A and an opposing second side 812B. A first electrically conductive varistor electrode 813A electrically connects the first side 812A to the terminal 806. A second electrically conductive varistor electrode 813B contacts the second side 812B and includes a joint tab 813C.

The integrated overcurrent protection circuit 814 includes a thermal disconnect mechanism 860, a spark gap assembly 880, a flexible electrical conductor 865, an arc chute or deion chamber 871, a triggering circuit 875 (including a triggering (semiconductive) spark gap assembly 850), a main spark gap 884, and a secondary spark gap 885.

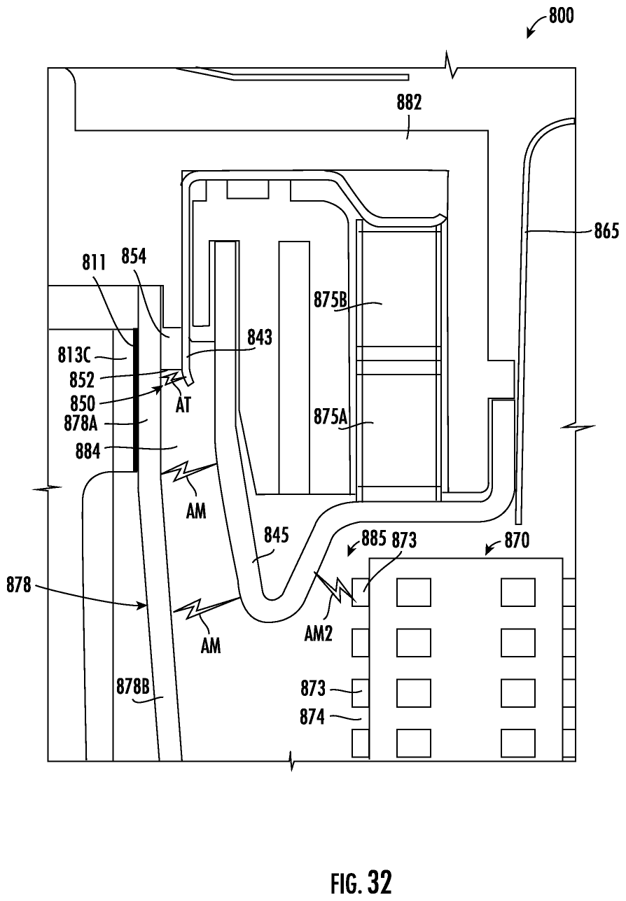

With reference to FIG. 32, the spark gap assembly 880 includes a spark gap carrier 882, a thermal disconnect joint electrode (second gap electrode) 878, a triggering electrode (first gap electrode) 843, and a movable deion plate 845 corresponding to and constructed as described for the spark gap carrier 782, the thermal disconnect joint electrode (second gap electrode) 778, the triggering electrode (first gap electrode) 743, and the movable deion plate 745, except as shown and as discussed below.

The triggering circuit 875 includes a varistor 875A connected in electrical series with a GDT 875B, and the triggering (semiconductive) spark gap assembly 850. The triggering spark gap assembly 850 includes the triggering electrode (first gap electrode) 843, the thermal disconnect joint electrode (second gap electrode) 878, and a semiconductive or trigger gap 852 defined between the electrodes 843 and 878. The triggering spark gap assembly 850 further includes a semiconductive member 854, corresponding to and constructed as described herein for the semiconductive member 154. The semiconductive member 854 spans the distance between and engages each of the electrodes 843 and 878.

A lower end 878B of the thermal disconnect joint electrode 878 is mounted on a post 803 of the housing 802 such that the thermal disconnect joint electrode 878 can pivot in a release direction E12 away from the joint tab 813C.

The main spark gap 884 is defined by and between the movable deion plate (third gap electrode) 845 and an opposing upper portion 878A of the thermal disconnect joint electrode 878. In some embodiments and as illustrated, the main spark gap 884 is a horn spark gap.

The deion chamber 871 includes an arc chute or deion plate set 870 and electrically insulating plate supports 871A. The deion plate set 870 may be constructed and operate in the same manner as described for the deion plate set 770, except as shown and as discussed below. The deion plate set 870 includes a series of arc chute or deion plates 873 that define a series of spark gaps 874 therebetween. Unlike the SPD 700, the SPD 800 does not include a fuse element corresponding to the fuse element 742. Instead, the deion plate set 870 is electrically floating between the terminal 704 and the varistor 812.

The secondary spark gap 885 is defined between the movable deion plate 845 and the uppermost deion plate 873 (i.e., the deion plate 873 closest to the movable deion plate 845).

The varistor 812, the varistor electrodes 813A, 813B (including the tab 813C), and the deion plates 873 are mounted to remain stationary in or relative to the housing 802.

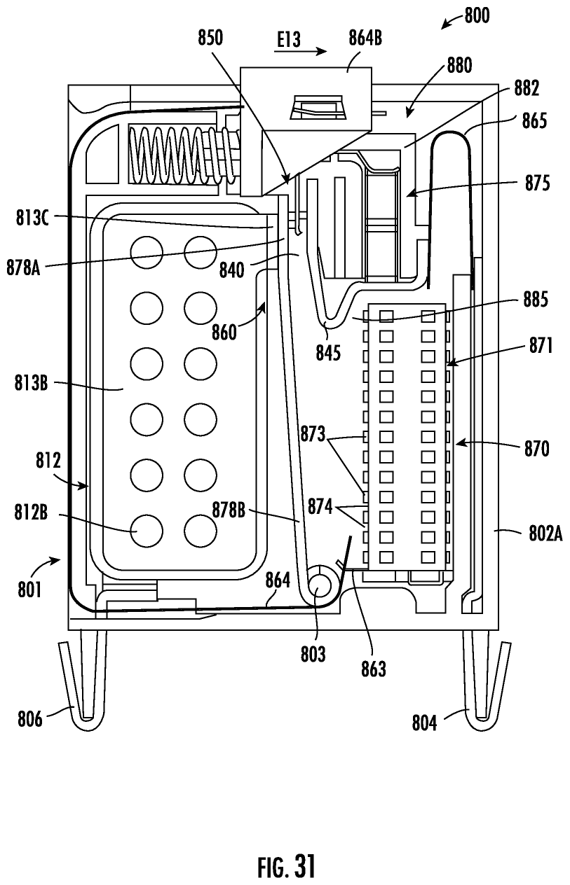

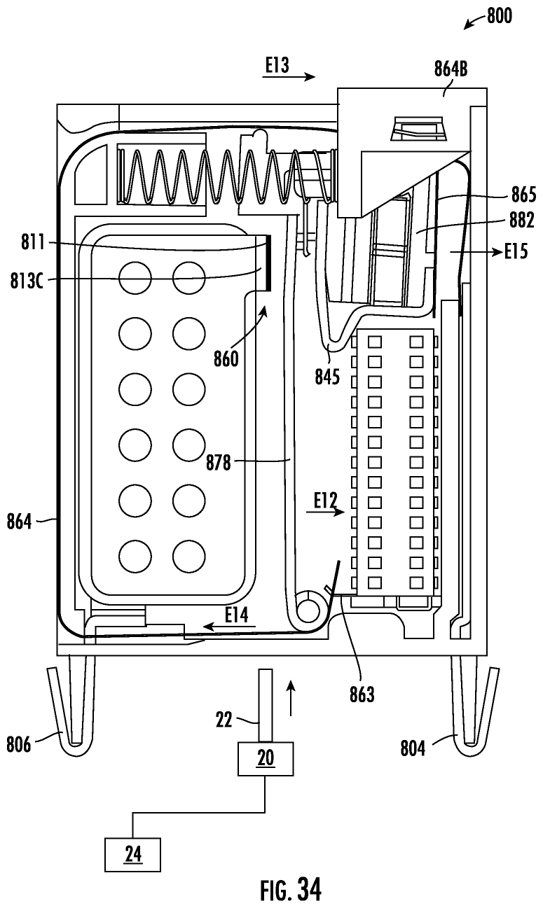

The spark gap carrier 882 is movably or slidably mounted in the housing 802 to move in a release direction E15 from a ready position (as shown in FIG. 31) to an open position (as shown in FIG. 34). The spark gap carrier 882 is biased, loaded, or urged in the direction E15 by a spark gap carrier spring 862. The disconnect joint electrode 878, the triggering electrode 843, the movable deion plate 845, the varistor 875A, the GDT 875B, the main spark gap 884, and the triggering spark gap assembly 850 (including the semiconductive member 854) are mounted on the spark gap carrier 882 for movement therewith in the same manner described for the spark gap assembly 780. The varistor 875A and the GDT 875B are arranged in electrical series between the triggering electrode 843 and the movable deion plate 845.

The thermal disconnect mechanism 860 includes the thermal disconnect joint electrode 878, the joint tab 813C, and a solder 811. The solder 811 bonds the thermal disconnect joint electrode 878 to the joint tab 813C to form a releasable joint 813D. As discussed below, the solder 811 can be heated by heat generated by the varistor 812 and/or the main spark gap 884, thereby causing the solder 811 to melt or soften and release the thermal disconnect joint electrode 878 from the joint tab 813C.

The thermal disconnect indicator mechanism 816 includes the spark gap carrier 882, the spring 862, a retention spring 863, an indicator element or strip 864, a guide slot 802A (defined in the housing 802), and a remote switch hole 802B (defined in the housing 802).

The overcurrent indicator mechanism 818 includes an indicator member 864B, a spring 864A, the retention spring 863, the indicator strip 864, and the hole 802B. The spring 864A urges the indicator member 864B in a direction E13.

The retention spring 863 is affixed to the lower end of the deion chamber 871. The retention spring 863 is disintegrable or meltable. The strip 864 is slidably seated in the guide slot 802A. One end of the strip 864 is affixed to the retention spring 863. The opposing end of the strip 864 is coupled to each of the spark gap carrier 882 and the indicator member 864B. The spark gap carrier 882 and the indicator member 864B are movable independently of one another such that each member 882, 864B can pull the indicator strip 864 while the other member 882, 864A remains stationary. The indicator strip 864 may be formed of a flexible, electrically nonconductive material.

According to some embodiments of the inventive concept, the SPD module 800 is configured to operate under the four different conditions discussed above with regard to the fused SPD module 100 (i.e., 1) normal (stand by) operation; 2) an overvoltage or current surge event in which the SPD module 800 is designed to shunt an SPD surge impulse current to ground; 3) a high short circuit (fault) event; and 4) a low short circuit (fault) event).

During normal operation, the varistor 812 practically acts as an insulator. The voltage applied across the triggering spark gap assembly 850 is insufficient to initiate a spark across the triggering spark gap assembly 850. The SPD module 800 remains in the configuration shown in FIG. 31 and no current is conducted through the triggering spark gap assembly 850 or the main spark gap 884.

When an overvoltage or current surge event (e.g., a transient power surge) applies a surge impulse current to the fused SPD circuit 801, the varistor 812 will temporarily go to a low impedance state (e.g., effectively becoming a short circuit), and the integrated overcurrent protection circuit 814 is supplied with an SPD surge impulse current. The varistor 812 is designed to shunt the surge impulse current associated with such events to ground to protect sensitive equipment. The SPD surge impulse current may be on the order of tens of kA, but will typically last only a short duration (in the range of from about tens of microseconds to a few milliseconds).

During the surge event and with reference to FIGS. 31 and 32, the current initially flows through the terminal 804, the flexible conductor 865, the movable deion plate 845, the varistor 875A, the GDT 875B, and the triggering electrode 843, across the triggering spark gap assembly 850, and through the thermal disconnect joint electrode 878, the electrode 813B, the varistor 812, and the electrode 813A to the terminal 806. The voltage applied across the trigger gap 852 by the surge event exceeds the prescribed threshold flashover voltage of the triggering spark gap assembly 850. In response, the voltage across the triggering spark gap assembly 850 initiates electrical arc flashover AT (as illustrated in FIG. 32) across the trigger gap 852. That is, electrical arcing AT is generated between the gap electrodes 843 and 878. The initiation of the electrical arc flashover AT is assisted by the semiconductive member 854 in response to the overvoltage developed across the electrodes 843, 878 in the same manner as described above for the semiconductive gap assembly 150 and the semiconductive member 154.

Shortly after the start of the electrical arc flashover AT (e.g., within microseconds), the current flow triggers an electric arc flashover AM (as illustrated in FIG. 32) across the main spark gap 884 between the electrodes 845 and 878. The full surge current is thereby diverted from the triggering circuit 875 to the main spark gap 884.

When the supplied surge current ceases, the voltage across the gap electrodes 843 and 878 and between the electrodes 845 and 878 drops below the ignition voltage, the flashover ends and the overcurrent protection circuit 814 stops conducting. The SPD module 800 may return to its standby mode. The SPD module 800 remains in its ready configuration and the indicator mechanisms 816, 818 are not triggered.

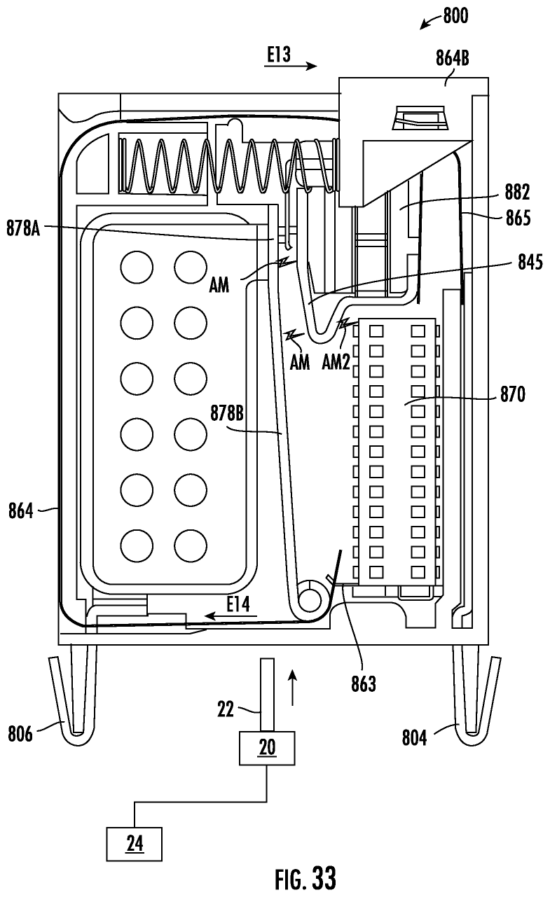

When a high short circuit event (condition 3) discussed above) occurs, the varistor 812 will supply the overcurrent protection circuit 814 with a relatively high SPD short circuit current. With reference to FIGS. 32 and 33, during the high short circuit event, the current initially flows through the terminal 804, the flexible conductor 865, the movable deion plate 845, the varistor 875A, the GDT 875B, and the triggering electrode 843, across the triggering spark gap assembly 850, and through the thermal disconnect joint electrode 878, the electrode 813B, the varistor 812, and the electrode 813A to the terminal 806. The voltage applied across the trigger gap 852 by the surge event exceeds the prescribed threshold flashover voltage of the triggering spark gap assembly 850. In response, the voltage across the triggering spark gap assembly 850 initiates electrical arc flashover AT (FIGS. 32 and 33) across the trigger gap 852. That is, electrical arcing AT is generated between the gap electrodes 843 and 878. The initiation of the electrical arc flashover AT is assisted by the semiconductive member 854 in response to the overvoltage developed across the electrodes 843, 878 in the same manner as described above for the semiconductive gap assembly 150 and the semiconductive member 154.

Shortly after the start of the electrical arc flashover AT (e.g., within microseconds), the current flow triggers an electric arc flashover AM (FIGS. 32 and 33) across the main spark gap 884 between the electrodes 845 and 878. The full surge current is thereby diverted from the triggering circuit 875 to the main spark gap 884.

As illustrated in FIGS. 32 and 33, after a period of time (e.g., from about 0.3 to 1 milliseconds), the electric arc flashover AM migrates to the secondary spark gap 885 to form an electric arc AM2 across the secondary spark gap 885 between the electrode 845 and the upper deion plate 873.

The arcing AM2 is redirected to arcing between the deion plates 873. Each deion plate arc creates a voltage drop between the electrode 845 and the electrode 878 (and thereby between the terminals 804, 806). These voltage drops add together increasing the voltage between the terminal 804 and the electrode 878 to relatively high values, until the voltage across the deion chamber 871 (and between the terminals 804 and 806) is higher than the power system voltage. The voltage drop developed on the deion chamber 871 opposes the mains voltage thus the fault current is rapidly reduced and eventually extinguished.

Thus, it will be appreciated that the electrical arc flashover AT triggers the electric arc flashover AM, which during high fault currents expands and propagates to the deion chamber 871. The expansion and propagation are driven by electromagnetic and acoustical forces. Once the arc AM2 enters the deion chamber 871, it is split into a plurality of smaller arcs and cooled down.

According to some embodiments, the SPD module 800 is further provided with a trigger disabling mechanism that, in response to the displacement of the indicator member 864B as discussed below (i.e., in direction E13, upon release of the indictor strip 864 by the melted retention spring 863), disables the triggering circuit 875. For example, the trigger disabling mechanism may move the gap electrode 843 away from the disconnect electrode 878. By way of further example, the movement of the indicator member 864 or other movement will disconnect the gap electrode 843 from the trigger MOV 875A. Once the triggering circuit 875 is thus opened or disabled, further triggering of the main spark gap 884 is prevented.

The overcurrent protection circuit 814 is thereby opened at the triggering spark gap 850 and the spark gaps 884, 885 and the fault current through the overcurrent protection circuit 814 and the SDP module 800 is cut off or interrupted. The thermal disconnect joint 813D remains intact.

It will be appreciated that a surge current will be relatively short in duration (in some embodiments, less than 0.5 milliseconds) and a high fault current will relatively long in duration (in some embodiments, at least 1 milliseconds). A surge current will not sustain the arc AM long enough to enable the arc AM to move or migrate to the secondary spark gap 885 and the deion chamber 870. As a result, the current is not directed through the deion chamber 870 during a surge event. By contrast, the high fault current (in a high short circuit event) will sustain the arc AM long enough to enable the arc AM to move or migrate to the secondary spark gap 885 so that the current is directed through the deion chamber 870 during a high short circuit event.

The high fault current also actuates the overcurrent indicator mechanism 818. During the high fault current, the arcing between the lower deion plates 873 proximate the retention spring 863 will cause the retention spring 863 to melt. The melting of the retention spring 863 enables the spring 864A to pull the indicator member 864B in the direction E13 and the indicator strip 864 in a direction E14, as illustrated in FIG. 33. This displacement of the indicator strip 864 enables a pin 22 of a remote sensor switch 20 to move into the housing 802 through the hole 802B. The change of state of the switch 20 is transmitted to a remote monitoring system 24 to indicate that the SPD module 700 has failed. The displacement of the indicator member 864B can also serve as a local alert or indicator. For example, the indicator member 864B may be visible through an opening in the housing.

When a low short circuit event (condition 4) discussed above) occurs, the varistor 812 will supply the overcurrent protection circuit 814 with a relatively low SPD short circuit current. With reference to FIGS. 32 and 34, during the low short circuit event, the current initially flows through the terminal 804, the flexible conductor 865, the movable deion plate 845, the varistor 875A, the GDT 875B, and the triggering electrode 843, across the triggering spark gap assembly 850, and through the thermal disconnect joint electrode 878, the electrode 813B, the varistor 812, and the electrode 813A to the terminal 806. The voltage applied across the trigger gap 852 by the surge event exceeds the prescribed threshold flashover voltage of the triggering spark gap assembly 850. In response, the voltage across the triggering spark gap assembly 850 initiates electrical arc flashover AT (FIG. 32) across the trigger gap 852. That is, electrical arcing AT is generated between the gap electrodes 843 and 878. The initiation of the electrical arc flashover AT is assisted by the semiconductive member 854 in response to the overvoltage developed across the electrodes 843, 878 in the same manner as described above for the semiconductive gap assembly 150 and the semiconductive member 154.

Shortly after the start of the electrical arc flashover AT (e.g., within microseconds), the current flow triggers an electric arc flashover AM (FIG. 32) across the main spark gap 884 between the electrodes 845 and 878. The full surge current is thereby diverted from the triggering circuit 875 to the main spark gap 884.

The low short circuit fault current then conducted through overcurrent protection circuit 814 is insufficient to interrupt the current in the manner described above for a high short circuit fault current. Instead, the heat generated by the varistor 812 is conducted to the solder 811 via the tab 813C, which causes the solder 811 to melt (e.g., soften). Additionally, the heat generated in the electric arc AM is also conducted to the solder 811 via the disconnect electrode 878 to contribute to the softening of the solder 811. As illustrated in FIG. 34, the melting of the solder 811 permits the spark gap carrier spring 862 to force the spark gap carrier 882, and thereby the disconnect electrode 878, in the direction E12 away from the tab 813C. The electrode 878 and the tab 813C are thereby spaced so far apart that the electrical circuit is opened therebetween. The fault current is thereby interrupted. The combination of the heating by the varistor 812 and the heating by the main spark gap 884 can increase the reliability and rate of response of the thermal disconnect mechanism 860.

Thus, it can be seen that the solder 811 is meltable in response to overheating in the SPD module 800 (by heat generated in the varistor 812 and the spark gap 884), and the thermal disconnector mechanism 860 is configured to displace the thermal disconnect joint electrode 878 away from the varistor electrode 813B and thereby electrically disconnect the varistor 812 from the spark gap 884. The spark gap 884 is defined by the electrodes 878 and 845. The displaceable thermal disconnect joint electrode 878 thus serves as both one of the spark gap electrodes and the moveable disconnect element of the thermal disconnector mechanism 860.

The low short circuit fault current also actuates the overcurrent indicator mechanism 818.

During the low fault current, the retention spring 863 is not melted. Instead, the release of the spark gap carrier 882 at the joint 813D enables the spark gap carrier spring 862 to pull the spark gap carrier 882, the indicator member 864B, and the indicator strip 864 in the directions E13, E14. This displacement of the indicator strip 864 enables the pin 22 of the remote sensor switch 20 to move into the housing 802 through the hole 802B. The change of state of the switch 20 is transmitted to a remote monitoring system 24 to indicate that the SPD module 800 has failed. The displacement of the indicator member 864B can also serve as a local alert or indicator. For example, the indicator member 864B may be visible through an opening in the housing.

The spark gap carrier 882 and the indicator member 864B are movable independently of one another. According to some embodiments, the spring force of the spring 864A is less than the spring force of the retention spring 863, which is less than the spring force of the spark gap carrier spring 862. Once the thermal disconnect mechanism 860 operates, the spark gap carrier spring 862 must pull the strip 864 by bending the retention spring 863, while the spring 864A should not be able to bend the retention spring 863 otherwise a false indication would be executed. However, when the SPD module 800 responds to and interrupts a high fault current, the spring 864A must be able to displace the strip 864 and the indicator member 864B upon melting of the retention spring 863.

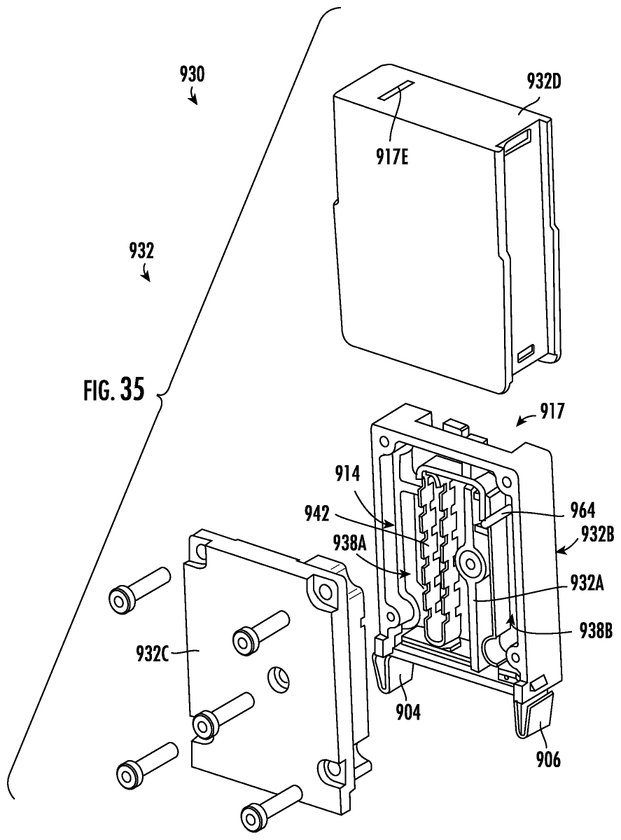

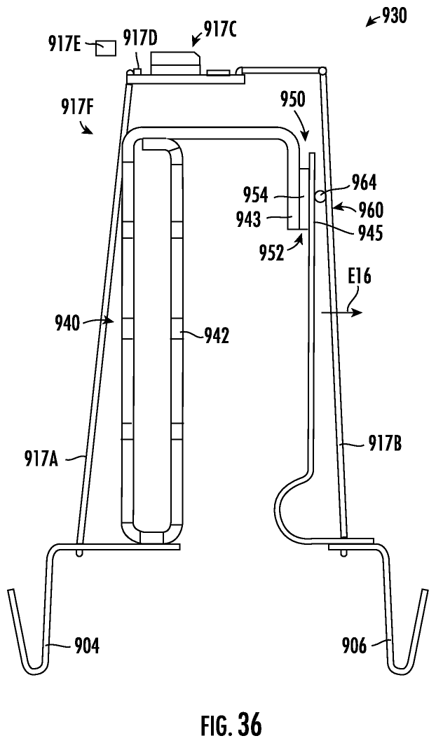

With reference to FIGS. 35 and 36, an SGA fuse assembly 930 according to further embodiments is shown therein.

In some embodiments, the SGA fuse assembly 930 is provided, installed and used as a component in a protection circuit of a power supply circuit 10 in place of the SGA fuse assembly 130 as shown in FIG. 1, for example.

The SGA fuse assembly 930 is configured to operate in the same manner as the SGA fuse assembly 330 in response to surge current events and high short circuit (fault) currents. The SGA fuse assembly 930 includes a first electrical contact or terminal 904, a second electrical contact or terminal 906, module housing assembly 932, an integrated overcurrent protection circuit 914, and an electronic indicator system 917.

The integrated overcurrent protection circuit 914 includes an SGA fuse element assembly 940 and a thermally-actuated disconnect mechanism 960. The thermally-actuated disconnect mechanism 960 corresponds to the disconnect mechanism 360 and is provided to interrupt a low short circuit (fault) current in the case of a low short circuit (fault) current event.

The module housing assembly 932 includes a first inner housing member 932B, a second inner housing member 932C, and a cover 932D that fitted over the housing members 932B, 932C. The housing member 932B includes an integral partition wall 932A and an integral meltable feature or post 964. The housing members 932B, 932C form an internal chamber. The partition wall 932A divides the chamber 938 into a fuse chamber 938A and a disconnect chamber 938B.

The SGA fuse element assembly 940 includes a fuse element 942 and a semiconductive gap assembly 950. The fuse element 942 may be constructed the same as the fuse element 142. The semiconductive gap assembly 950 includes a semiconductive or trigger gap 952, a first gap electrode 943, a second gap electrode 945, and a semiconductive member 954 corresponding to the trigger gap 152, the gap electrode 143, the gap electrode 145, and the semiconductive member 154, respectively. The first gap electrode 943 is an end of the fuse element 942. The second gap electrode 945 is a movable contact forming a part of the disconnect mechanism 960.

The thermal disconnect mechanism 960 includes the movable contact 945 and a meltable retainer element 964. According to some embodiments (e.g., as illustrated), the movable contact 945 is a spring leg. According to some embodiments, the meltable retainer element 964 is a post or other feature forming a part of or attached to the housing assembly 932. In the illustrated disconnect mechanism 960, the movable contact 945 is a resilient metal spring strip and the meltable retainer element 964 is a post forming a part of the inner housing member 932B. The post 964 holds the spring leg 945 in an elastically deflected state as shown in FIG. 36 such that the spring 945 applies a load in a disconnect direction E16 away from the trigger gap 952. The meltable post 964 holds the spring 945 in position relative to the gap electrode 943 against the deflection load of the spring leg 945.

The trigger gap 952 is defined by and between the opposing gap electrodes 943 and 945. The semiconductive member 954 is positioned in the gap 952 and interposed between the gap electrodes 943 and 945. The semiconductive member 954 is connected in electrical series between the fuse element 942 and the movable contact 945. In some embodiments and as illustrated, the opposed end faces of the semiconductive member 954 are each in electrical contact with a respective one of the gap electrodes 943, 945.

The indicator system 917 includes a first wire 917A, a second wire 917B, a printed circuit board assembly 917C (including a light emitting diode (LED) 917D), and a lens 917E. The wire 917A electrically connects the PCB 917C to the terminal 904 and the wire 917B electrically connects the PCB 917C to the terminal 906. When illuminated, the LED 917D is visible exterior of the housing assembly 932 through the lens 917E to alert an observer that the SGA fuse assembly 930 has failed. It will be appreciated that the wires 917A, 917B and PCB 917C form an electrical indicator circuit 917F parallel to the overcurrent protection circuit 914 (formed by the SGA fuse element assembly 940 and the thermally-actuated disconnect mechanism 960) between the terminals 704, 706.

The SGA fuse assembly 930 is configured to respond to surge current events, high short circuit events, and low short circuit events in the same manners as described for the SGA fuse assembly 330, except as follows. The deflected spring leg 945 serves as the second gap electrode in place of the movable contact 345. The thermal disconnect mechanism 960 operates in place of the thermal disconnect mechanism 360. The indicator system 917 is triggered in response failure of the SGA fuse assembly 930 (as discussed below).

Regarding the operation of the thermal disconnect mechanism 960, as discussed above with regard to the SGA fuse assembly 330, the low short circuit fault current conducted through the SGA fuse element assembly 940 is insufficient to interrupt the current in the manner described above for a high short circuit fault current. Instead, the heat generated by the arcing across the semiconductive gap assembly 950 is conducted to the meltable post 964, which causes the meltable post 964 to melt (e.g., soften). The melting of the meltable post 964 permits the deflected spring leg (movable gap electrode) 945 to pull away from the gap electrode 943 in direction E16, thereby disconnecting the terminal 906 from the fuse element 942. The fault current is thereby interrupted.

The indicator system 917 operates as both a thermal disconnect indicator system and an overcurrent indicator system. The PCB 917C has a threshold current level below which the LED 917D is illuminated and above which the LED 917D is not illuminated. During normal operation, high fault current events, and low fault current events when the SGA fuse element assembly 940 is intact and the thermal disconnect mechanism 960 is not actuated (i.e., the spring leg 945 is in contact with the semiconductive member 954), the current between the terminals 904, 906 is divided between the overcurrent protection circuit 914 and the indicator circuit 917F so that the current through the PCB 917C remains below the threshold current level.

However, when the SGA fuse assembly 930 experiences a high fault current that disintegrates the fuse element 942 and thereby opens the overcurrent protection circuit 914 to interrupt the fault current through the overcurrent protection circuit 914, all the current is then directed through indicator circuit 917F. The applied current exceeds the threshold current level and illuminates the LED to signal that the SGA fuse assembly 930 has failed.

Similarly, when the when the SGA fuse assembly 930 experiences a low fault current that opens the thermal disconnect mechanism 960 and thereby opens the overcurrent protection circuit 914 to interrupt the fault current through the overcurrent protection circuit 914, all the current is then directed through the indicator circuit 917F. The applied current exceeds the threshold current level and illuminates the LED to signal that the SGA fuse assembly 930 has failed.

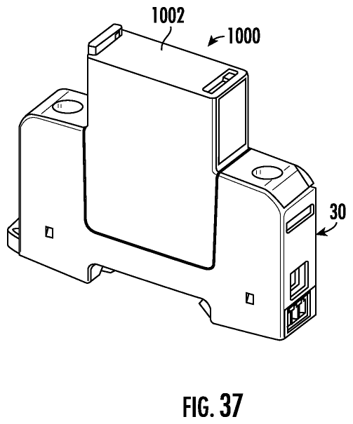

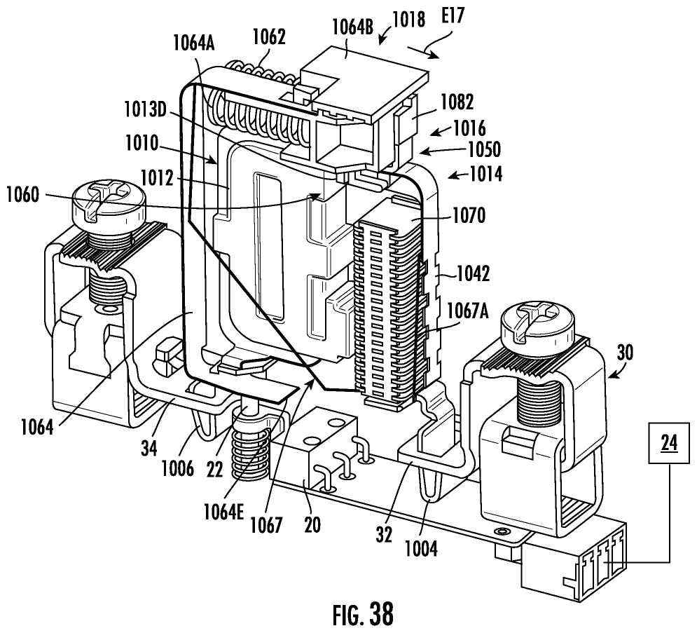

With reference to FIGS. 37 and 38, a fused SPD module 1000 according to further embodiments is shown therein. The fused SPD module 1000 includes a module housing 1002, a first electrical contact or terminal 1004, a second electrical contact or terminal 1006, an overvoltage protection circuit (OPC) 1010, an integrated overcurrent protection circuit 1014, a thermal disconnect indicator mechanism 1016, and an overcurrent indicator mechanism 1018 corresponding to, constructed and operating in the same manner as the module housing 702, the first terminal 704, the second terminal 706, the OPC 710, the integrated overcurrent protection circuit 714, the thermal disconnect indicator mechanism 716, and the overcurrent indicator mechanism 718, except as discussed below.

In some embodiments, the SPD module 1000 is provided, installed and used as a component in a protection circuit of a power supply circuit 10 in place of the SPD module 100 as shown in FIG. 1, for example.

The fused SPD module 1000 is removably and replaceably mounted in a base 30. The fused SPD module 1000 is electrically and mechanically connected to electrical terminals 32, 34 of the base by the terminals 704, 706 when mounted in the base 30. The base 30 may be, for example, a DIN rail mountable base.

The fused SPD module 1000 includes an MOV 1012 (optionally and as illustrated in FIG. 38, encased in an epoxy layer), a triggering spark gap assembly 1050, a fuse element 1042, a deion plate set 1070, a spark gap carrier 1082, and a spark gap carrier spring 1062 corresponding to, constructed and operating in the same manner as the MOV 712, the triggering spark gap assembly 750, the fuse element 742, the deion plate set 770, the spark gap carrier 782, and the spark gap carrier spring 762. In some embodiments, a capacitor is provided in electrical parallel with the MOV (e.g., below the epoxy).

In the overcurrent protection circuit 1014, the fuse element 1042 is routed along the side of the deion plate set 1070 opposite the MOV 1012 and the triggering spark gap assembly 1050.

The overcurrent protection circuit 1014, includes a triggering circuit corresponding to the triggering circuit 775. In some embodiments, the triggering circuit of the module 1000 includes only a triggering GDT (corresponding to the GDT 775B) and does not include a varistor corresponding to the varistor 775A.

The overcurrent indicator mechanism 1018 includes an indicator member 1064B, a spring 1064A, an indicator strip 1064, and an electrically resistive element or wire 1067 The spring 1064A urges the indicator member 1064B in a direction E17.

A first end of the resistive wire 1067 is secured to the spark gap carrier 1082 and the opposite end of the resistive wire 1067 is secured to the indicator member 1064B. A section 1067A of the resistive wire 1067 extends along (in contact with or closely adjacent) the deion chamber 1070. The resistive wire 1067 is disintegrable or meltable in response to a sufficient current flowing therethrough. The resistive wire 1067 is slidably seat in one more guide slots in the module housing (not shown).

The strip 1064 is slidably seated in in one more guide slots in the module housing (not shown). One end 1064E of the strip 1064 is free. The opposing end of the strip 1064 is coupled to the indicator member 1064B. The indicator strip 1064 may be formed of a flexible, electrically nonconductive material.

The indicator member 1064B is movable independently of the spark gap carrier 1082 such that the indicator member 1064B can pull the indicator strip 1064 while the spark gap carrier 1082 remains stationary.

The spark gap carrier 1082 is coupled to the indicator member 1064B such that the spark gap carrier 1082 will pull the indicator member 1064B and the indicator strip 1064 when the spark gap carrier 1082 is displaced by the spring 1062.

The fused SPD module 1000 will respond to a high short circuit event (condition 3) discussed above) as discussed above for the fused SPD module 700, except in the operation of the overcurrent indicator mechanism 1018. Instead of melting the retention spring 763, the resistive wire 1067 is disintegrated or melted. More particularly, a portion of the high fault current is diverted through the resistive wire 1067 from the deion plates of the deion chamber 1070 and causes the resistive wire 1067 to break by disintegrating or melting.

The breaking of the resistive wire 1067 enables the spring 1064A to pull the indicator member 1064B and the indicator strip 1064 in a direction E17 (FIG. 38). This displacement of the indicator strip 1064 enables a pin 22 of a remote sensor switch 20 to move into the housing 1002 through the hole (not shown). The change of state of the switch 20 is transmitted to a remote monitoring system 24 to indicate that the SPD module 1000 has failed. The displacement of the indicator member 1064B can also serve as a local alert or indicator. For example, the indicator member 1064B may be visible through an opening in the housing.

The fused SPD module 1000 will respond to a low short circuit event (condition 4) discussed above) as discussed above for the fused SPD module 700, except in the operation of the overcurrent indicator mechanism 1018.

The low short circuit fault current also actuates the overcurrent indicator mechanism 1018. During the low fault current, the resistive wire 1067 is not disintegrated or broken. Instead, the release of the spark gap carrier 1082 at the soldered thermal disconnect joint 1013D (corresponding to joint 713D) enables the spark gap carrier spring 1062 to pull the spark gap carrier 1082 and the indicator strip 1064 in the direction E17. The intact resistive wire 1067 is likewise pulled around. This displacement of the indicator strip 1064 enables the pin 22 of the remote sensor switch 20 to move into the housing 1002 through the hole 1002B. The change of state of the switch 20 is transmitted to a remote monitoring system 24 to indicate that the SPD module 1000 has failed. The displacement of the spark gap carrier 1082 can also serve as a local alert or indicator. For example, the spark gap carrier 1082 may be visible through an opening in the housing.

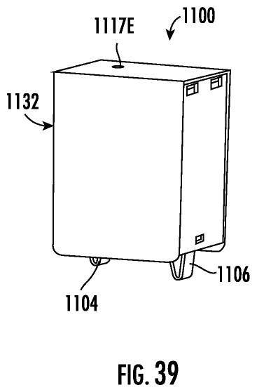

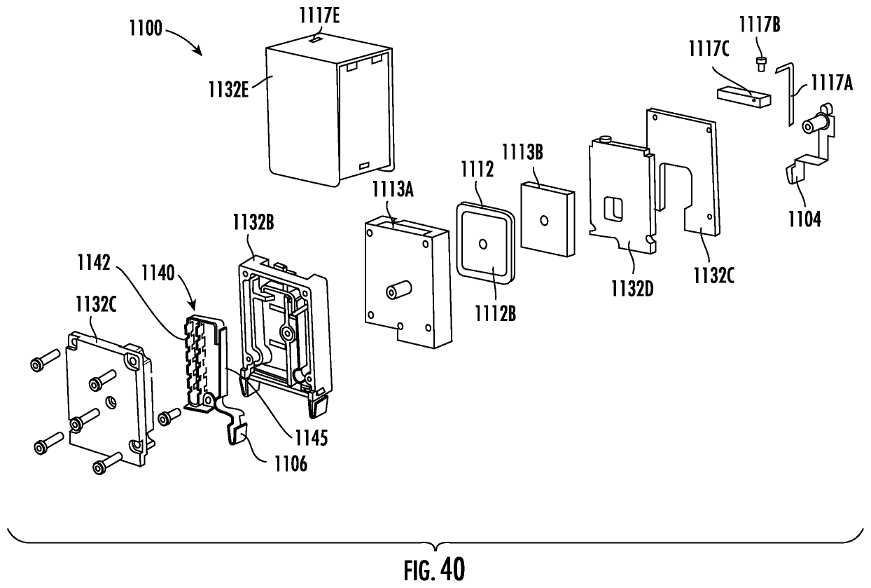

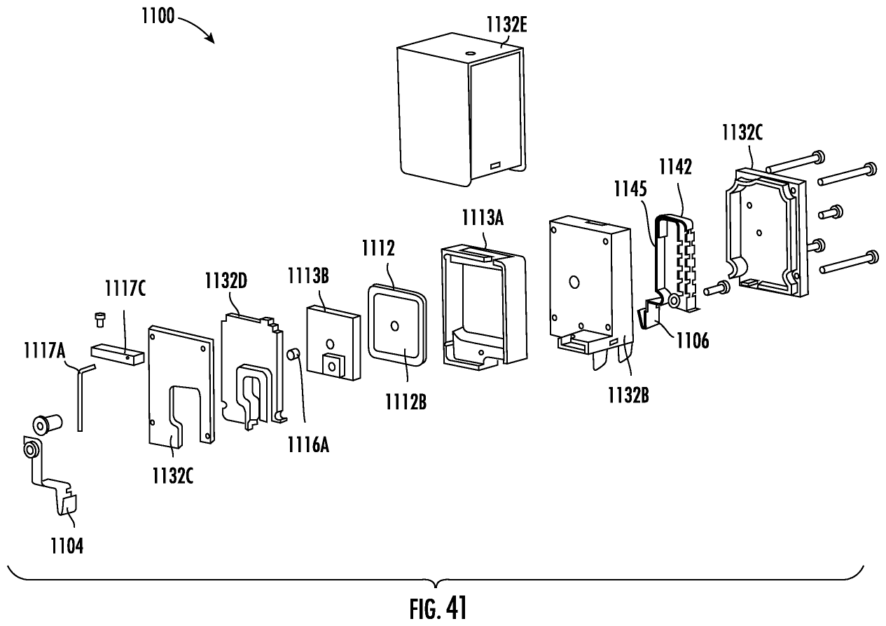

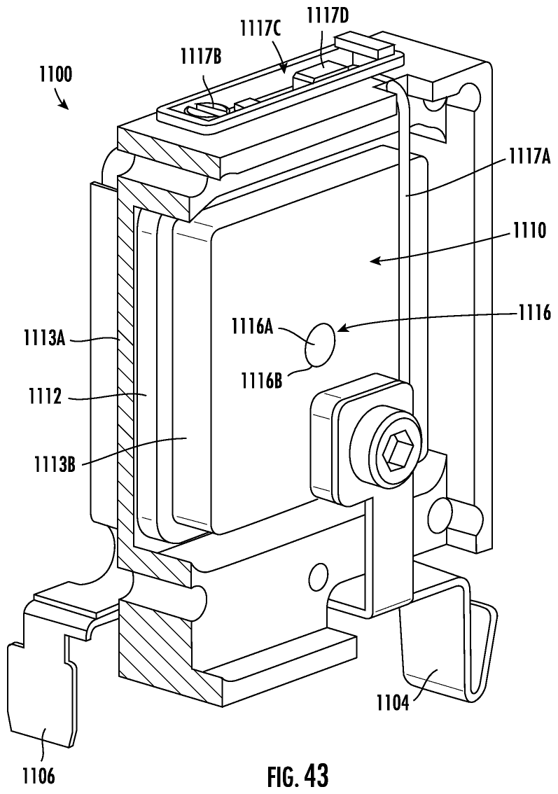

With reference to FIGS. 39-43, a fused SPD module 1100 according to further embodiments is shown therein.

The SPD module 1100 includes a module housing assembly 1132, a first electrical contact or terminal 1104, a second electrical contact or terminal 1106, an overvoltage protection circuit (OPC) 1110, an integrated overcurrent protection circuit 1114, a varistor (MOV) fail-safe mechanism 1116, and an electronic overcurrent indicator system 1117. The overcurrent protection circuit 1114 and the OPC 1110 are disposed in the housing assembly 1132, and are electrically connected between the terminals 1104 and 1106 to form an SPD electrical circuit 1101.

In some embodiments, the SPD module 1100 is provided, installed and used as a component in a protection circuit of a power supply circuit 10 in place of the SPD module 100 as shown in FIG. 1, for example.

The module housing assembly 1132 includes an inner housing frame member 1132B, a pair of side covers 1132C, a rubber spacer 1132D, and an outer cover 1132E that fitted over the components 1132B, 1132C, 1132D. The inner housing frame member 1132B includes an integral partition wall 1132A and an integral meltable feature or post 1164. The housing members 1132B, 1132C form an internal chamber 1138. The partition wall 1132A divides the chamber 1138 into a fuse chamber 1138A and a disconnect chamber 1138B.

The integrated overcurrent protection circuit 1114 includes an SGA fuse element assembly 1140 and a thermally-actuated disconnect mechanism 1160. The thermally-actuated disconnect mechanism 1160 corresponds to the disconnect mechanism 360 and is provided to interrupt a low short circuit (fault) current in the case of a low short circuit (fault) current event.

The SGA fuse element assembly 1140 includes a fuse element 1142, a fuse element electrode 1141, and a semiconductive gap assembly 1150.

The fuse element 1142 may be constructed the same as the fuse element 142.

The fuse element electrode 1141 electrically connects an end 1142A of the fuse element 1142 to the electrically conductive housing member 1113A discussed below.

The semiconductive gap assembly 1150 includes a semiconductive or trigger gap 1152, a first gap electrode 1143, a second gap electrode 1145, and a semiconductive member 1154 corresponding to the trigger gap 152, the gap electrode 143, the gap electrode 145, and the semiconductive member 154, respectively. The first gap electrode 1143 is the end of the fuse element 1142 opposite the end 1142A. The second gap electrode 1145 is a movable contact forming a part of the disconnect mechanism 1160.

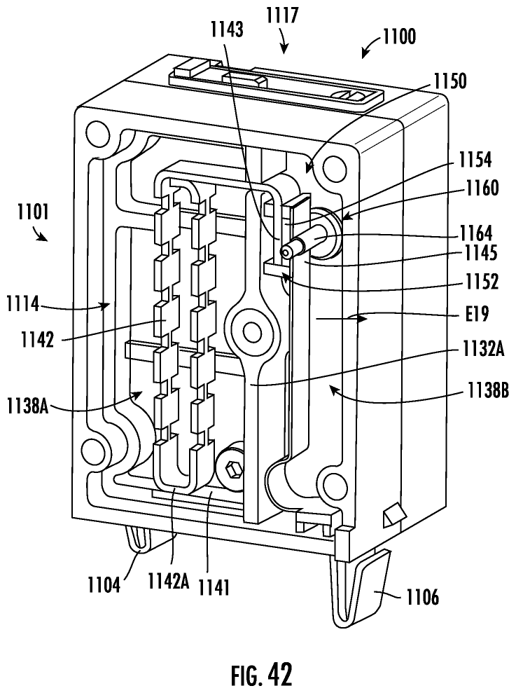

The thermal disconnect mechanism 1160 includes the movable contact 1145 and a meltable retainer element 1164. According to some embodiments (e.g., as illustrated), the movable contact 1145 is a spring leg. According to some embodiments, the meltable retainer element 1164 is a post or other feature forming a part of or attached to the housing assembly 1132. In the illustrated disconnect mechanism 1160, the movable contact 1145 is a resilient metal spring strip and the meltable retainer element 1164 is a post forming a part of the inner housing frame 1132B. The post 1164 holds the spring leg 1145 in an elastically deflected state as shown in FIG. 42 such that the spring 1145 applies a load in a disconnect direction E19 away from the trigger gap 1152. The meltable post 1164 holds the spring 1145 in position relative to the gap electrode 1143 against the deflection load of the spring leg 1145.

The trigger gap 1152 is defined by and between the opposing gap electrodes 1143 and 1145. The semiconductive member 1154 is positioned in the gap 1152 and interposed between the gap electrodes 1143 and 1145. The semiconductive member 1154 is connected in electrical series between the fuse element 1142 and the movable contact 1145. In some embodiments and as illustrated, the opposed end faces of the semiconductive member 1154 are each in electrical contact with a respective one of the gap electrodes 1143, 1145.

The OPC 1110 includes a varistor 1112, a first electrically conductive varistor electrode 1113A, a second electrically conductive varistor electrode 1113B, and a fail-safe mechanism 1116.

In some embodiments, the varistor 1112 is an MOV. The varistor 1112 has a first side 1112A and an opposing second side 1112B. A through hole 1112C is defined in the varistor 1112 and connects the sides 1112A, 1112B. The first varistor electrode 1113A electrically connects the first side 1112A to the terminal 1106. The second varistor electrode 1113B contacts the second side 1112B and electrically connects the second side 1112B to the fuse element 1142 via the electrode 1141.

The fail-safe mechanism 1116. includes a meltable member 1116A disposed in a hole 1116B defined in the varistor electrode 1113B.

The indicator system 1117 includes a wire 1117A, a screw 1117B, a printed circuit board assembly 1117C (including a LED 1117D), and a lens 1117E. The wire 1117A electrically connects the PCB 1117C to the terminal 1104 and the screw 1117B electrically connects the PCB 1117C to the terminal 1106 (via the electrode 1113A, the electrode 1141, the fuse element 1142, and the electrode 1145). When illuminated, the LED 1117D is visible exteriorly of the housing assembly 1132 through the lens 1117E to alert an observer that the overcurrent protection circuit 1114 has failed. It will be appreciated that the components 1117A, 1117B, 1117C form an electrical indicator circuit 1117F between the terminals 1104, 1106.

The fuses SPD assembly 1100 is configured to respond to surge current events, high short circuit events, and low short circuit events in the same manners as described for the SGA fuse assembly 930, except as discussed below.

During normal operation, the varistor 1112 practically acts as an insulator. The voltage applied across the triggering spark gap assembly 1150 is insufficient to initiate a spark across the trigger spark gap 1152. The fused SPD module 1100 remains in the configuration shown in FIG. 42 and no current is conducted through the fuse element 1142.

When an overvoltage or current surge event (e.g., a transient power surge) applies a surge impulse current to the fused SPD circuit 1101, the varistor 1112 will temporarily go to a low impedance state (e.g., effectively becoming a short circuit), and the integrated overcurrent protection circuit 1114 is supplied with an SPD surge impulse current.

During the surge event, the current flows through the terminal 1106, through the spring leg 1145, across the triggering spark gap assembly 1150, through the fuse element 1142, through the electrode 1113A, through the varistor 1112, and through the electrode 1113B to the terminal 1104. The voltage applied across the trigger gap 1152 by the surge event exceeds the prescribed threshold flashover voltage of the triggering spark gap assembly 1150. In response, the voltage across the triggering spark gap assembly 1150 initiates electrical arc flashover (corresponding to the electric arc flashover AT of triggering spark gap assembly 1150) across the trigger gap 1152 between the gap electrodes 1143 and 1145. The initiation of the electrical arc flashover is assisted by the semiconductive member 1154 in response to the overvoltage developed across the electrodes 1143, 1145 in the same manner as described above for the semiconductive gap assembly 150 and the semiconductive member 154. As discussed with regard to the SGA fuse element assembly 140, the fused SPD assembly 1100 is capable of conducting this SPD surge impulse current without disintegrating or significantly degrading the SGA fuse element assembly 1140 (i.e., without disintegrating or significantly degrading the fuse element 1142 or the semiconductive member 1154).

When a high short circuit event (condition 3) discussed above) occurs, the OPC 1110 will supply the fuse element assembly 1140 with a relatively high SPD short circuit current. The voltage applied across the gap 1152 by the high short circuit event exceeds the prescribed threshold flashover voltage of the semiconductive gap assembly 1150 and initiates electrical arc flashover across the gap 1152 between the gap electrodes 1143 and 1145 as described above with regard to the semiconductive member 154. The high fault current disintegrates portions of the fuse element 1142, creating one or more voltage drops between the terminals. These voltage drops add together and increasingly reduce the voltage across the semiconductive gap assembly 1150 until the voltage across the semiconductive gap assembly 1150 is less than the ignition voltage necessary to sustain the arcing between the gap electrodes 1143, 1145 and less than necessary to trigger flashover between the gap electrodes 1143, 1145 or to conduct current through or along the surface of the semiconductive member 1154. The fused SPD module 1100 is thereby opened at the semiconductive gap assembly 1150 and the fault current through the fused SDP module 1100 is cut off or interrupted.

When a low short circuit event (condition 4) discussed above) occurs, the OPC 1110 will supply the overcurrent protection circuit 1114 with a relatively low SPD short circuit current. During the low short circuit event, the voltage applied across the semiconductive gap assembly 1150 by the low short circuit event exceeds the prescribed threshold flashover voltage of the semiconductive gap assembly 350. In response, the voltage across the semiconductive gap assembly 1150 initiates electrical arc flashover across the trigger gap 1152. During the low short circuit event, the semiconductive member 1154 functions as a spark gap trigger that assists in initiating the flashover between the gap electrodes 1143, 1145 in the same manner as described above for the semiconductive member 154.

The thermal disconnect mechanism 1160 operates in the same manner as the thermal disconnect mechanism 960. As discussed above with regard to the SGA fuse assembly 930, the low short circuit fault current conducted through the SGA fuse element assembly 1140 is insufficient to interrupt the current in the manner described above for a high short circuit fault current. Instead, the heat generated by the arcing across the semiconductive gap assembly 1150 is conducted to the meltable post 1164, which causes the meltable post 1164 to melt (e.g., soften). The melting of the meltable post 1164 permits the deflected spring leg (movable gap electrode) 1145 to pull away from the gap electrode 1143 in direction E19, thereby disconnecting the terminal 1106 from the fuse element 1142. The fault current is thereby interrupted.

The indicator system 1117 operates as both a thermal disconnect indicator system and an overcurrent indicator system and in a manner different from that described above for the indicator system 917. The PCB 1117C has a threshold current level below which the LED 1117D is not illuminated and above which the LED 1117D is illuminated. During normal operation, high fault current events, and low fault current events when the SGA fuse element assembly 1140 is intact and the thermal disconnect mechanism 1060 is not actuated, the current between the terminals 1104, 1106 remains above the threshold current level and the LED 1117D is illuminated to indicate that the overcurrent protection circuit 1114 is working properly.

However, when the fused SDP module 1100 experiences a high fault current that opens the overcurrent protection circuit 1114, no current is supplied to the indicator circuit 1117F. As a result, the LED 1117D is no longer illuminated, which signals that the SGA fuse assembly 1130 has failed.

Similarly, when the fused SDP module 1100 experiences a low fault current that opens the thermal disconnect mechanism 1160, no current is supplied to the indicator circuit 1117F. As a result, the LED 1117D is no longer illuminated, which signals that the SGA fuse assembly 1130 has failed.

The fail-safe mechanism 1116 is triggered when the varistor 1112 fails and overheats. When heated to a threshold temperature by heat generated in the varistor 1112, the meltable member 1116A will melt and flow out of the hole 1116B and into and through the hole 1112C to bridge and electrically connect the electrodes 1113A, 1113B. The meltable member 1116A thereby redirects the current applied to the OPC 1110 to bypass the varistor 1112 so that current induced heating of the varistor 1112 ceases. The fail-safe mechanism 1116 may thereby serve to prevent or inhibit thermal runaway and catastrophic failure of the varistor 1112. Actuation of the fail-safe mechanism 1116 may create a high short circuit event (condition 3) that disintegrates the fuse element 1142 as described above.

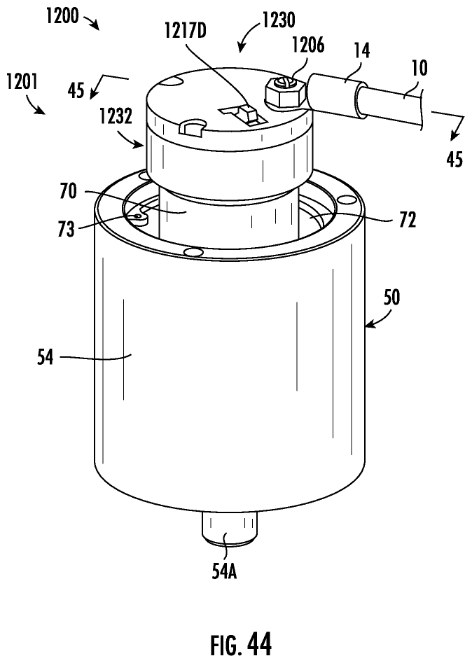

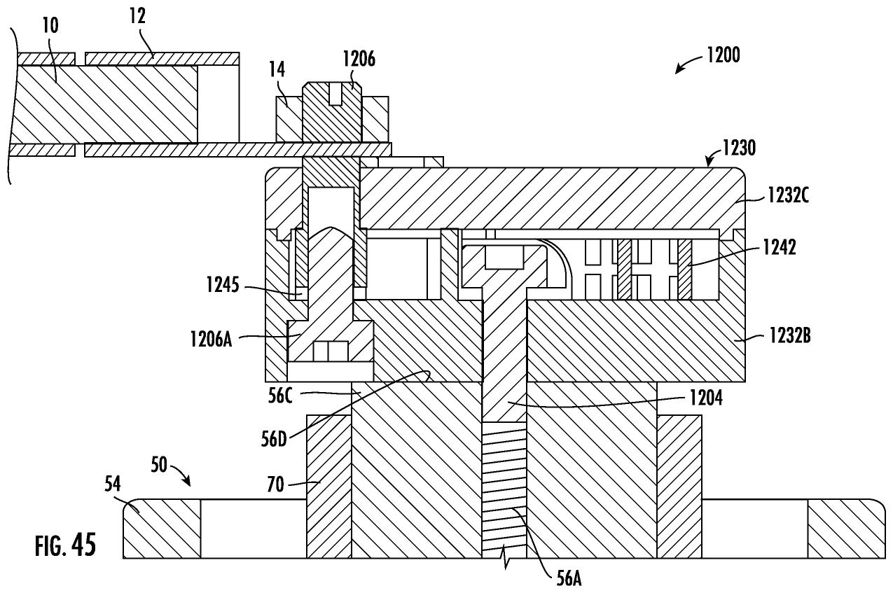

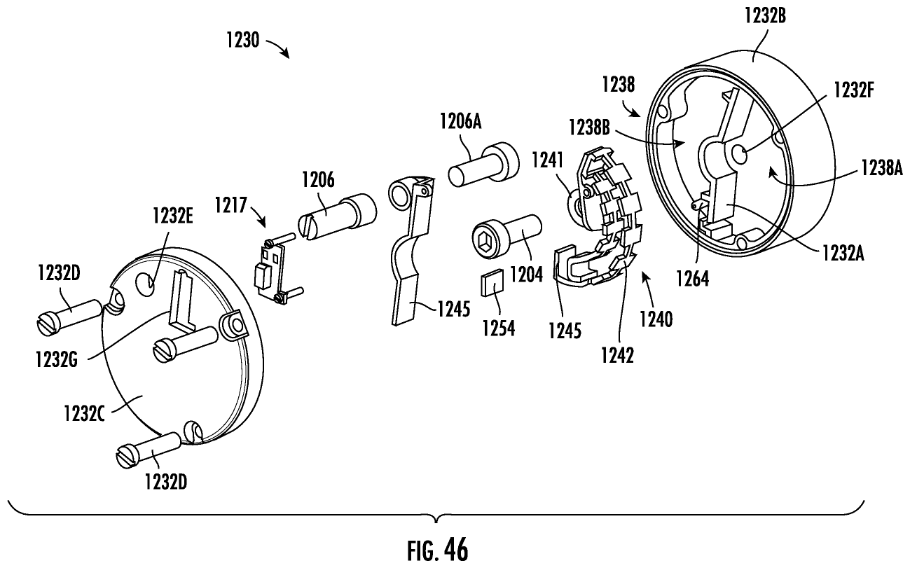

With reference to FIGS. 44-47, a fused SPD module 1200 according to further embodiments is shown therein. The fused SPD module 1200 includes an SGA fuse assembly module 1230 and the OPC module 50, which are electrically and mechanically joined to form the integrated fused SPD module 1200. The SGA fuse assembly module 1230 and the OPC module 50 together form an SPD electrical circuit 1201.

The OPC module 50 is described above and shown in FIG. 6 in more detail.

The SGA fuse assembly module 1230 includes a module housing assembly 1232, a first electrical contact or terminal 1204, a second electrical contact or terminal 1206, an integrated overcurrent protection circuit 1214, and an overcurrent indicator system 1217.

The module housing assembly 1232 includes a cup-shaped main housing member 1232B and a cover 1232C, fastened together by bolts 1232D. The main housing member 1232B includes an integral partition wall 1232A and an integral meltable feature or post 1264. The housing members 1232B, 1232C form an internal chamber 1238. The partition wall 1232A divides the chamber 1238 into a fuse chamber 1238A and a disconnect chamber 1238B.

The terminal 1206 projects through a hole 1232E in the cover 1232C. In use, a power line 10 can be connected to the terminal 1206 with a lug 12 and nut 14, for example.

The terminal 1204 is a threaded member (e.g., a bolt, threaded pin or threaded post) that projects through a hole 1232F in the bottom wall of the main housing member 1232B.

The integrated overcurrent protection circuit 1214 includes an SGA fuse element assembly 1240 and a thermally-actuated disconnect mechanism 1260. The thermally-actuated disconnect mechanism 1260 corresponds to the disconnect mechanism 1160 and is provided to interrupt a low short circuit (fault) current in the case of a low short circuit (fault) current event.

The SGA fuse element assembly 1240 includes a fuse element 1242, a fuse element electrode 1241, and a semiconductive gap assembly 1250.

The fuse element electrode 1241 electrically connects an end 1242A of the fuse element 1242 to the piston electrode shaft 56C of the OPC module 50 as discussed below.

The semiconductive gap assembly 1250 includes a semiconductive or trigger gap 1152, a first gap electrode 1243, a second gap electrode 1245, and a semiconductive member 1254 corresponding to the trigger gap 1152, the gap electrode 1143, the gap electrode 1145, and the semiconductive member 1154, respectively. The first gap electrode 1243 is the end of the fuse element 1242 opposite the end 1242A. The second gap electrode 1245 is a movable contact forming a part of the disconnect mechanism 1260.

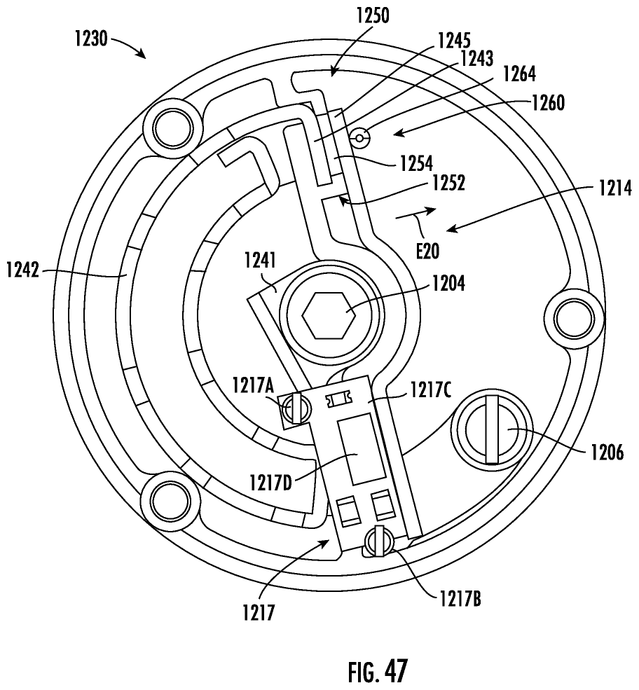

The thermal disconnect mechanism 1260 includes the movable contact 1245 and a meltable retainer element 1264. According to some embodiments (e.g., as illustrated), the movable contact 1245 is a spring leg. According to some embodiments, the meltable retainer element 1264 is a post or other feature forming a part of or attached to the housing assembly 1232. In the illustrated disconnect mechanism 1260, the movable contact 1245 is a resilient metal spring strip and the meltable retainer element 1264 is a post forming a part of the main housing member 1232B. The post 1264 holds the spring leg 1245 in an elastically deflected state as shown in FIG. 47 such that the spring 1245 applies a load in a disconnect direction E20 away from the trigger gap 1252. The meltable post 1264 holds the spring 1245 in position relative to the gap electrode 1243 against the deflection load of the spring leg 1245. The fixed end of the spring leg 1245 is electrically connected to the terminal 1206 with a screw 1206A.

The trigger gap 1252 is defined by and between the opposing gap electrodes 1243 and 1245. The semiconductive member 1254 is positioned in the gap 1252 and interposed between the gap electrodes 1243 and 1245. The semiconductive member 1254 is connected in electrical series between the fuse element 1242 and the movable contact 1245. In some embodiments and as illustrated, the opposed end faces of the semiconductive member 1254 are each in electrical contact with a respective one of the gap electrodes 1243, 1245.

The SGA fuse assembly module 1230 is mechanically secured directly to the end of the OPC module 50 by the threaded terminal 1204. The terminal 1204 extends through the hole 1232F and is threaded into the bore 56A to fasten the SGA fuse assembly module 1230 to the shaft 56C of the piston electrode 56. The fuse electrode 1241 is thereby electrically connected to the piston electrode 56. In some embodiments, the housing assembly 1232 is mounted in direct contact with the OPC module 50 to form a unitary structure. In some embodiments and as illustrated, the housing assembly 1232 is mounted in direct contact with the piston electrode 56. In some embodiments and as illustrated, the piston electrode 56 and the housing assembly 1232 have complementary mating surfaces, e.g., as illustrated. The power line 10 is secured to the terminal 1206 with the lug 12 and the nut 14. The other line (not shown in FIGS. 44-47) is connected to the terminal post 54A. In other embodiments, the connections may be reversed so that the SGA fuse assembly module 1230 is instead mounted on the terminal post 54A and is directly supported by the housing electrode 54.

The indicator system 1217 includes a screw 1217A, a screw 1217B, a printed circuit board assembly 1217C (including a LED 1217D), and an opening 1232G in the cover 1232C. The screw 1217A electrically connects the PCB 1217C to the terminal 1104 and the screw 1217B electrically connects the PCB 1217C to the terminal 1206.

The fused SPD module 1200 will operate as described above for the fused SPD module 1100. The integrated overcurrent protection circuit 1214 will respond to surge current events, high short circuit events, and low short circuit events in the same manners as described for the overcurrent protection circuit 1114.

The OPC module 50 will respond to surge current events, high short circuit events, and low short circuit events in the same manners as described for the OPC 1110. The fail-safe mechanism 62 will serve the function of the fail-safe mechanism 1116.

The indicator system 1217 will operate in the same manner as described for the indicator system 1117 to serve as both a thermal disconnect indicator system and an overcurrent indicator system.

It will be appreciated that the construction of the SGA fuse assembly module 1230 can enable the SGA fuse assembly module 1230 to be modularly and mechanically mounted on and electrically connected to an OPC module 50 that is not always intended for use with an integral fuse circuit. For example, the OPC module 50 may be a STRIKESORB™ SPD available from Raycap, S.A. of Greece.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed is:

1. An electrical protection assembly comprising:
a semiconductive gap-assisted (SGA) fuse assembly forming an overcurrent protection circuit and including:
a fuse element; and
a semiconductive gap assembly electrically connected in series with the fuse element, wherein the semiconductive gap assembly includes:
a first gap electrode and an opposing second gap electrode;
a trigger gap defined between the first and second gap electrodes; and
a semiconductive member disposed in the trigger gap;
wherein the semiconductive member is configured to assist in initiation of an electrical arc flashover across the trigger gap between the first and second gap electrodes responsive to an overvoltage developed across the first and second gap electrodes.

2. The electrical protection assembly of claim 1 wherein the semiconductive member is formed of a composition including a mixture of a polymeric material, as a nonconductive matrix, and an electrically conductive filler.

3. The electrical protection assembly of claim 1 wherein the semiconductive member is formed of a semiconductive ceramic selected from the group consisting of zinc oxide, barium titanate, and silicon carbide.

4. The electrical protection assembly of claim 1 wherein the fuse element is a bimetallic fuse element including:
a first metal layer having a first coefficient of thermal expansion; and
a second metal layer having a second coefficient of thermal expansion;
wherein the first coefficient of thermal expansion is greater than the second coefficient of thermal expansion;
wherein the bimetallic fuse element is configured to disintegrate in response to a current flowing through the bimetallic fuse element;
wherein the bimetallic fuse element is configured to bend in a deformation direction, due to the difference in the coefficients of thermal expansion of the first and second metal layers, in response to heat generated in the bimetallic fuse element by the current flowing through the bimetallic fuse element; and
wherein said bending assists in extinguishing electrical arcing from the bimetallic fuse element.

5. The electrical protection assembly of claim 1 wherein a portion of the fuse element forms the first gap electrode or the second gap electrode.

6. The electrical protection assembly of claim 1 including a second fuse element, wherein the semiconductive gap assembly is connected in electrical series between the first and second fuse elements.

7. The electrical protection assembly of claim 6 wherein:
a portion of the first fuse element forms the first gap electrode; and
a portion of the second fuse element forms the second gap electrode.

8. The electrical protection assembly of claim 1 including a thermal disconnect mechanism configured to disconnect the overcurrent protection circuit in response to a current insufficient to disintegrate the fuse element.

9. The electrical protection assembly of claim 8 wherein the thermal disconnect mechanism includes a spring-loaded electrode and a meltable retainer.

10. The electrical protection assembly of claim 1 including a deion chamber connected in electrical in series with the semiconductive gap assembly.

11. The electrical protection assembly of claim 10 wherein the deion chamber is connected in electrical series with the fuse element.

12. The electrical protection assembly of claim 10 wherein the deion chamber is connected in electrical parallel with the fuse element.

13. The electrical protection assembly of claim 12 wherein:
the deion chamber includes a set of serially spaced apart deion plates; and
the fuse element extends along and in contact with the deion plates.

14. The electrical protection assembly of claim 1 including an overcurrent failure indicator system configured to signal when the overcurrent protection circuit is interrupted.

15. The electrical protection assembly of claim 14 wherein the overcurrent failure indicator system is electronic.

16. The electrical protection assembly of claim 1 wherein the electrical protection assembly is a fused surge protective device (SPD) including an overvoltage protection circuit connected in electrical series with the SGA fuse assembly to form a fused SPD circuit.

17. The electrical protection assembly of claim 16 wherein:
the fused SPD includes:
an SPD module housing; and
first and second electrical terminals on the SPD module housing; and
the overvoltage protection circuit and the overvoltage protection circuit are disposed in the SPD module housing.

18. The electrical protection assembly of claim 16 wherein the overvoltage protection circuit includes a voltage-switching/limiting component.

19. The electrical protection assembly of claim 18 wherein the voltage-switching/limiting component is a varistor, a spark gap, a diode or a thyristor.

20. The electrical protection assembly of claim 19 wherein the overvoltage protection circuit includes a gas discharge tube connected in electrical series with the voltage-switching/limiting component.

21. The electrical protection assembly of claim 18 wherein the overvoltage protection circuit includes a thermal disconnect mechanism configured to interrupt the fused SPD circuit in response to heat from the voltage-switching/limiting component and/or from the semiconductive gap assembly.

22. The electrical protection assembly of claim 21 wherein the thermal disconnect mechanism includes a solder joint.

23. The electrical protection assembly of claim 18 wherein the overvoltage protection circuit includes a fail-safe mechanism configured to short circuit the overvoltage protection circuit in response to heat from the voltage-switching/limiting component.

24. The electrical protection assembly of claim 16 including a third gap electrode and a main spark gap defined at least in part by the third gap electrode, wherein the electrical protection assembly is configured such that the electrical arc flashover will propagate into and through the main spark gap from the trigger gap.

25. The electrical protection assembly of claim 24 including a varistor and/or a gas discharge tube connected in electrical series with the semiconductive member and in electrical parallel with the main spark gap.

26. The electrical protection assembly of claim 16 including a deion chamber connected in electrical series with semiconductive gap assembly.

27. The electrical protection assembly of claim 16 including:
an overcurrent failure indicator system configured to signal when the overcurrent protection circuit is interrupted; and
an overvoltage indicator system configured to signal when the overvoltage protection circuit is interrupted.

28. The electrical protection assembly of claim 16 including:
an SPD module including the overvoltage protection circuit; and
a fuse assembly module;
wherein the fuse assembly module is mounted on and secured to the SPD module such that the SPD module and the fuse assembly module in combination form a unitary fused SPD module.

29. The electrical protection assembly of claim 28 wherein:
the SPD module includes:
a housing electrode including an end wall and an integral sidewall collectively defining a cavity, wherein the housing electrode is unitarily formed of metal;
a piston electrode extending into the cavity; and
a varistor wafer disposed in the cavity between the housing electrode and the piston electrode; and
the fuse assembly module is mounted on the piston electrode or the housing electrode.

30. The electrical protection assembly of claim 16 wherein:
the overvoltage protection circuit includes a voltage-switching/limiting component;
the fused SPD includes:
a spark gap assembly, the spark gap assembly including a first spark gap electrode and a second spark gap electrode defining a spark gap therebetween; and
a thermal disconnector mechanism positioned in a ready configuration, wherein the voltage-switching/limiting component is electrically connected in electrical series with the spark gap, the thermal disconnector mechanism being repositionable to electrically disconnect the voltage-switching/limiting component from the spark gap, the thermal disconnector mechanism including:
the first spark gap electrode;
a voltage-switching/limiting component electrode electrically connecting the spark gap to the voltage-switching/limiting component; and
a solder securing the first spark gap electrode in electrical connection with the voltage-switching/limiting component electrode in the ready configuration;
wherein:
the solder is meltable in response to overheating in the fused SPD; and
the thermal disconnector mechanism is configured to displace the first spark gap electrode away from the voltage-switching/limiting component electrode and thereby electrically disconnect the voltage-switching/limiting component from the spark gap when the solder is melted.

31. A surge protective device comprising:
a voltage-switching/limiting component;
a spark gap assembly, the spark gap assembly including a first spark gap electrode and a second spark gap electrode defining a spark gap therebetween; and
a thermal disconnector mechanism positioned in a ready configuration, wherein the voltage-switching/limiting component is electrically connected in electrical series with the spark gap, the thermal disconnector mechanism being repositionable to electrically disconnect the voltage-switching/limiting component from the spark gap, the thermal disconnector mechanism including:
the first spark gap electrode;
a voltage-switching/limiting component electrode electrically connecting the spark gap to the voltage-switching/limiting component; and
a solder securing the first spark gap electrode in electrical connection with the voltage-switching/limiting component electrode in the ready configuration;
wherein:
the solder is meltable in response to overheating in the surge protective device; and
the thermal disconnector mechanism is configured to displace the first spark gap electrode away from the voltage-switching/limiting component electrode and thereby electrically disconnect the voltage-switching/limiting component from the spark gap when the solder is melted.

32. The surge protective device of claim 31 wherein the spark gap is a horn spark gap.
